(19) United States
(12) Patent Application Publication
(10) Pub. No.: US 2019/0118995 A1
(43) Pub. Date: Apr. 25, 2019

(54) PRODUCT TRAY

(71) Applicant: KapStone Container Corporation, Northbrook, IL (US)

(72) Inventors: Gregory V. PAGE, Canby, OR (US); Michael B. MCLEOD, Romeoville, IL (US)

(21) Appl. No.: 16/167,654

(22) Filed: Oct. 23, 2018

Related U.S. Application Data
(60) Provisional application No. 62/576,248, filed on Oct. 24, 2017.

(51) Int. Cl. B65D 5/32; B65D 5/00; B65D 5/44; B65D 5/42

(52) U.S. Cl. CPC B65D 5/322; B65D 5/0045; B31B 2120/70; B65D 5/4204; B65D 5/443

(57) ABSTRACT

A product tray includes a body defining a product-storage space and a product-view window extending through the body into the product-storage space. The body includes a front wall, a back wall spaced apart from the front wall, a pair of spaced apart side walls extending from the front wall to the back wall, and a floor extending between lower ends of the front wall and the back wall and between lower ends of the side walls. The product-storage space adapted to receive and hold product for transportation to and display in a retail location, and the product-view window arranged to allow a consumer at the retail location to view the product stored in the product product-storage space.

### PRIORITY CLAIM

This application claims priority under 35 U.S.C. § 119(e) to U.S. Provisional Application Ser. No. 62/576,248, filed Oct. 24, 2017, which is expressly incorporated by reference herein.

### BACKGROUND

The present disclosure relates to a tray, and particularly to a tray adapted to hold products. More particularly, the present disclosure relates to a product tray made from corrugated material.

### SUMMARY

A product tray in accordance with the present disclosure includes a body defining a product-storage space and a product-view window extending through the body into the product-storage space. The body includes a front wall, a back wall spaced apart from the front wall, a pair of spaced apart side walls extending from the front wall to the back wall, and a floor extending between lower ends of the front wall and the back wall and between lower ends of the side walls. The product-storage space adapted to receive and hold product for transportation to and display in a retail location, and the product-view window arranged to allow a consumer at the retail location to view the product stored in the product product-storage space.

In illustrative embodiments, the body is formed of a sheet material, and the walls and floor of the body are formed to include two or more layers of the sheet material in thickness for maximizing crush strength and bending strength of the product tray. Upper corners of the body are formed to define platforms configured to provide a supporting surface configured to receive an additional product tray thereon to form a stack of product trays. One or more alignment tabs extend upwardly from the body and are configured to engage with one or more slots formed in a lower portion of the additional product tray to align the product tray with the additional product tray in the stack of product trays.

In illustrative embodiments, the product tray is formed from a base portion and a reinforcement portion. The base portion is formed from a base blank of the sheet material having a plurality of panels foldable relative to one another. The reinforcement portion is formed from a reinforcement blank of the sheet material having a plurality of panels foldable relative to one another. Sections of the base portion overlap with sections of the reinforcement portion to provide two or more layers of sheet material in the floor and walls of the product tray.

In illustrative embodiments, the base blank includes a plurality of base panels, a first plurality of base flaps coupled along a first side of the plurality of base panels and a second plurality of base flaps coupled along an opposing second side of the plurality of base panels. The plurality of base panels includes a base-mid panel and a pair of base-end panels coupled to opposing ends of the base-mid panel. The base panels and base flaps of the base blank are foldable relative to one another to form the base portion. The reinforcement blank includes a plurality of reinforcement panels, a first plurality of reinforcement flaps coupled along a first side of the plurality of reinforcement panels and a second plurality of reinforcement flaps coupled along an opposing second side of the plurality of reinforcement panels. The plurality of reinforcement panels includes a reinforcement-mid panel and a pair of reinforcement-end panels coupled to opposing ends of the reinforcement-mid panel. The reinforcement panels and reinforcement flaps of the reinforcement blank are foldable relative to one another to form the reinforcement portion.

In illustrative embodiments, the sheet material of the base blank includes a plurality of flutes extending along the sheet material in a first direction. The sheet material of the reinforcement blank includes a plurality of flutes extending along the sheet material in a second direction. The base portion and reinforcement portion are bonded together such that the first direction and the second direction are perpendicular to one another.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is an upper perspective view of an embodiment of a product tray in accordance with the present disclosure showing that the product tray includes a front wall formed to include a product-view window, a back wall spaced apart from the front wall, a pair of side walls extending from the front wall to the back wall, and a floor and suggesting that upper corners of the product tray include a platform for receiving another product tray thereon and alignment tabs to aid in stacking of the product trays;

FIG. 2 is an exploded assembly view of the product tray of FIG. 1 showing that the product tray is formed from a base portion and a reinforcement portion that attaches to the base portion and suggesting that the base portion and reinforcement portion are erected from blanks as shown in FIGS. 5 and 6;

FIG. 3 is a rear perspective view of the product tray of FIG. 1;

FIG. 4 is an exploded assembly view of the product tray of FIG. 3;

FIG. 5 is a top plan view of one embodiment of a reinforcement blank in accordance with the present disclosure used to form the reinforcement portion of the product tray of FIG. 2;

FIG. 6 is a top plan view of one embodiment of a base blank in accordance with the present disclosure used to form the base portion of the product tray of FIG. 2;

FIG. 7 is an upper perspective view of another embodiment of a product tray in accordance with the present disclosure showing that the product tray includes a front wall formed to include a product-view window, a back wall spaced apart from the front wall, a pair of side walls extending from the front wall to the back wall, and a floor and suggesting that upper corners of the product tray include a platform for receiving another product tray thereon and alignment tabs to aid in stacking of the product trays;

FIG. 8 is an exploded assembly view of the product tray of FIG. 7 showing that the product tray is formed from a base portion and a reinforcement portion that attaches to the base portion and suggesting that the base portion and reinforcement portion are erected from blanks shown in FIGS. 9 and 10;

FIG. 9 is a top plan view of one embodiment of a reinforcement blank in accordance with the present disclosure used to form the reinforcement portion of the product tray of FIG. 8;

FIG. 10 is a top plan view of one embodiment of a base blank in accordance with the present disclosure used to form the base portion of the product tray of FIG. 8;

FIG. 11 is an exploded assembly view of another embodiment of a product tray in accordance with the present disclosure showing that the product tray is formed from a base portion having strips that form beveled corner edges of the base portion and a reinforcement portion that attaches to the base portion;

FIG. 12 is an upper perspective view of the product tray of FIG. 11 showing that the product tray includes a front wall formed to include a product-view window, a back wall spaced apart from the front wall, a pair of side walls extending from the front wall to the back wall, and a floor and suggesting that upper corners of the product tray include a platform for receiving another product tray thereon and alignment tabs to aid in stacking of the product trays;

FIG. 13 is a top plan view of one embodiment of a reinforcement blank in accordance with the present disclosure used to form a reinforcement portion of the product tray of FIG. 12;

FIG. 14 is a top plan view of one embodiment of a base blank in accordance with the present disclosure used to form a base portion of the product tray of FIG. 12;

FIG. 15 is an upper perspective view of another embodiment of a product tray in accordance with the present disclosure showing that the product tray includes a front wall formed to include a product-view window, a back wall spaced apart from the front wall, a pair of side walls extending from the front wall to the back wall, and a floor and suggesting that upper corners of the product tray form a platform for receiving another product tray thereon and define alignment tabs to aid in stacking of the product trays;

FIG. 16 is a top plan view of one embodiment of a reinforcement blank in accordance with the present disclosure used to form a reinforcement portion of the product tray of FIG. 15;

FIG. 17 is a top plan view of one embodiment of a base blank in accordance with the present disclosure used to form a base portion of the product tray of FIG. 15;

FIG. 18 is an upper perspective view of another embodiment of a product tray in accordance with the present disclosure showing that the product tray includes a front wall formed to include a product-view window, a back wall spaced apart from the front wall, a pair of side walls extending from the front wall to the back wall, and a floor;

FIG. 19 is an upper perspective view of the product tray of FIG. 18 showing the product tray positioned over another similar product tray for forming a stack of product trays as suggested in FIG. 20;

FIG. 20 is an upper perspective view a stack of product trays formed from the product trays of FIG. 19 showing that alignment tabs of the lower product tray engage with notches of the upper product tray to aid in alignment and stacking of the product trays;

FIG. 21 is a top plan view of one embodiment of a reinforcement blank in accordance with the present disclosure used to form a reinforcement portion of the product tray of FIG. 18;

FIG. 22 is a top plan view of one embodiment of a base blank in accordance with the present disclosure used to form a base portion of the product tray of FIG. 18;

FIG. 23 is an upper perspective view of another embodiment of a product tray in accordance with the present disclosure showing that the product tray includes a front wall formed to include a product-view window, a back wall spaced apart from the front wall, a pair of side walls extending from the front wall to the back wall, and a floor and suggesting that upper corners of the product tray include a platform for receiving another product tray thereon and alignment tabs to aid in stacking of the product trays;

FIG. 24 is a top plan view of one embodiment of a reinforcement blank in accordance with the present disclosure used to form a reinforcement portion of the product tray of FIG. 23;

FIG. 25 is a top plan view of one embodiment of a base blank in accordance with the present disclosure used to form a base portion of the product tray of FIG. 23;

FIG. 26 is an upper perspective view of another embodiment of a product tray in accordance with the present disclosure showing that the product tray includes a front wall formed to include a product-view window, a back wall spaced apart from the front wall, a pair of side walls extending from the front wall to the back wall, and a floor and suggesting that upper corners of the product tray include a platform for receiving another product tray thereon and alignment tabs to aid in stacking of the product trays;

FIG. 27 is an exploded assembly view of the product tray of FIG. 26 showing that the product tray is formed from a base portion and a reinforcement portion that attaches to the base portion and suggesting that the base portion and reinforcement portion are erected from blanks shown in FIGS. 29 and 30;

FIG. 28 is view similar to FIG. 27 showing the product tray partially erected;

FIG. 29 is a top plan view of one embodiment of a reinforcement blank in accordance with the present disclosure used to form the reinforcement portion of the product tray of FIG. 27;

FIG. 30 is a top plan view of one embodiment of a base blank in accordance with the present disclosure used to form the base portion of the product tray of FIG. 27;

FIG. 31 is an upper perspective view of another embodiment of a product tray in accordance with the present disclosure showing that the product tray includes a front wall formed to include a product-view window, a back wall spaced apart from the front wall, a pair of side walls extending from the front wall to the back wall, a floor, and a product divider coupled to the floor and suggesting that the product tray is erected from blanks shown in FIGS. 32 and 33;

FIG. 32 is a top plan view of one embodiment of a reinforcement blank in accordance with the present disclosure used to form a reinforcement portion of the product tray of FIG. 31;

FIG. 33 is a top plan view of one embodiment of a base blank in accordance with the present disclosure used to form a base portion of the product tray of FIG. 31;

FIG. 34 is an upper perspective view of another embodiment of a product tray in accordance with the present disclosure showing that the product tray includes a front wall formed to include a product-view window, a back wall spaced apart from the front wall, a pair of side walls extending from the front wall to the back wall, and a floor and suggesting that upper corners of the product tray include a platform for receiving another product tray thereon and alignment tabs to aid in stacking of the product trays;

FIG. 35 is an exploded assembly view of the product tray of FIG. 34 showing that the product tray is formed from a base portion and a reinforcement portion that attaches to the base portion and suggesting that the base portion and reinforcement portion are erected from blanks shown in FIGS. 37 and 38;

FIG. 36 is view similar to FIG. 35 showing the product tray partially erected;

FIG. 37 is a top plan view of one embodiment of a reinforcement blank in accordance with the present disclosure used to form the reinforcement portion of the product tray of FIG. 35;

FIG. 38 is a top plan view of one embodiment of a base blank in accordance with the present disclosure used to form the base portion of the product tray of FIG. 35;

FIG. 39 is an upper perspective view of another embodiment of a product tray in accordance with the present disclosure showing that the product tray includes a front wall formed to include a product-view window, a back wall spaced apart from the front wall, a pair of side walls extending from the front wall to the back wall, and a floor and suggesting that upper corners of the product tray include a platform for receiving another product tray thereon and alignment tabs to aid in stacking of the product trays;

FIG. 40 is a top plan view of one embodiment of a reinforcement blank in accordance with the present disclosure used to form a reinforcement portion of the product tray of FIG. 39; and

FIG. 41 is a top plan view of one embodiment of a base blank in accordance with the present disclosure used to form a base portion of the product tray of FIG. 39.

### DETAILED DESCRIPTION

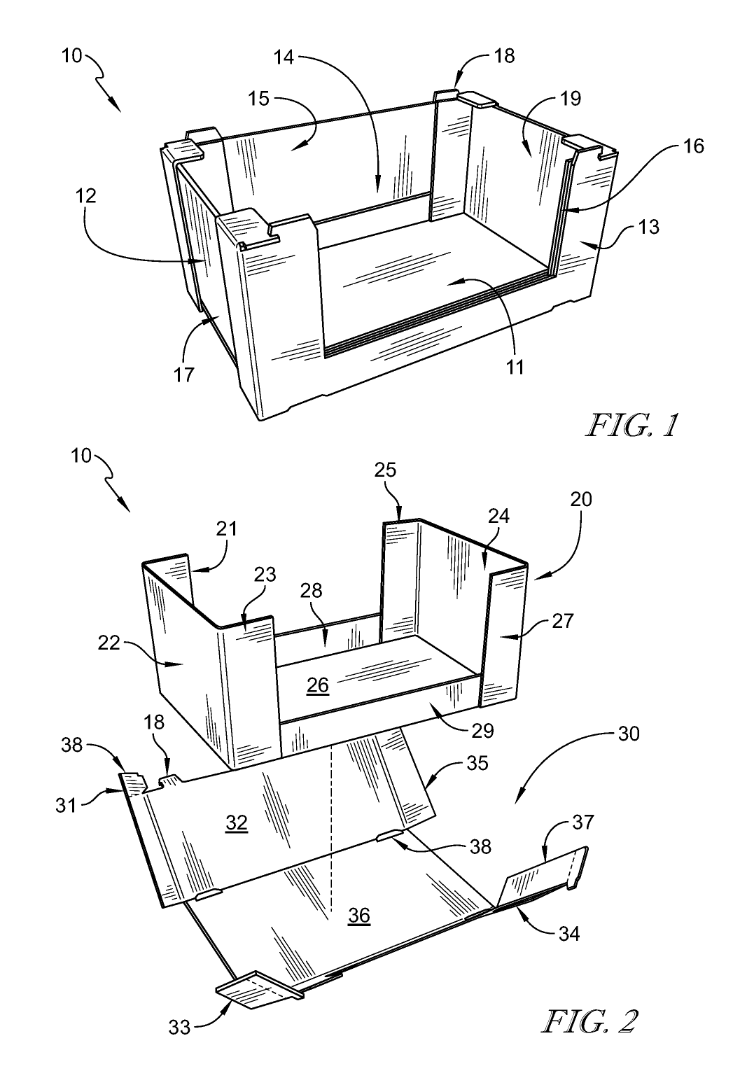

One embodiment of a product tray 10 in accordance with the present disclosure is shown in FIG. 1. Product tray 10 includes body 12 defining a product-storage space 14 and a product-view window 16 extending through body 12 into product-storage space 14. Product-storage space 14 is configured to receive and hold product for transportation to and display in a retail location. Product-view window 16 allows a consumer at the retail location to view the product stored in product tray 10.

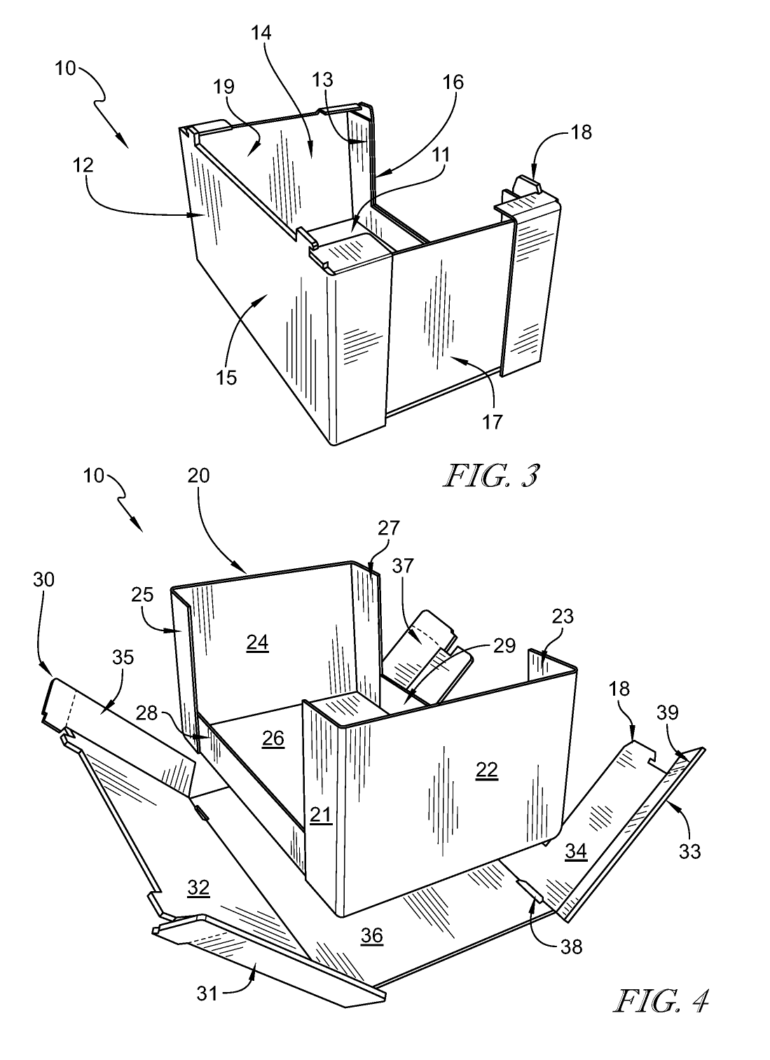

Body 12 of product tray 10 includes a front wall 13, a back wall 15 spaced apart from front wall 13, a pair of side walls 17, 19 extending from front wall 13 to the back wall 15, and a floor 11 as shown in FIGS. 1 and 3. Front wall 13 is formed to include product-view window 16. Upper corners of product tray 10 form a platform for receiving another product tray 10 thereon and define alignment tabs 18 to aid in stacking of product trays 10. In some embodiments, side walls 17, 19 are perpendicular to floor 11. In some embodiments, side walls 17, 19 are angled toward or away from one another relative to floor 11.

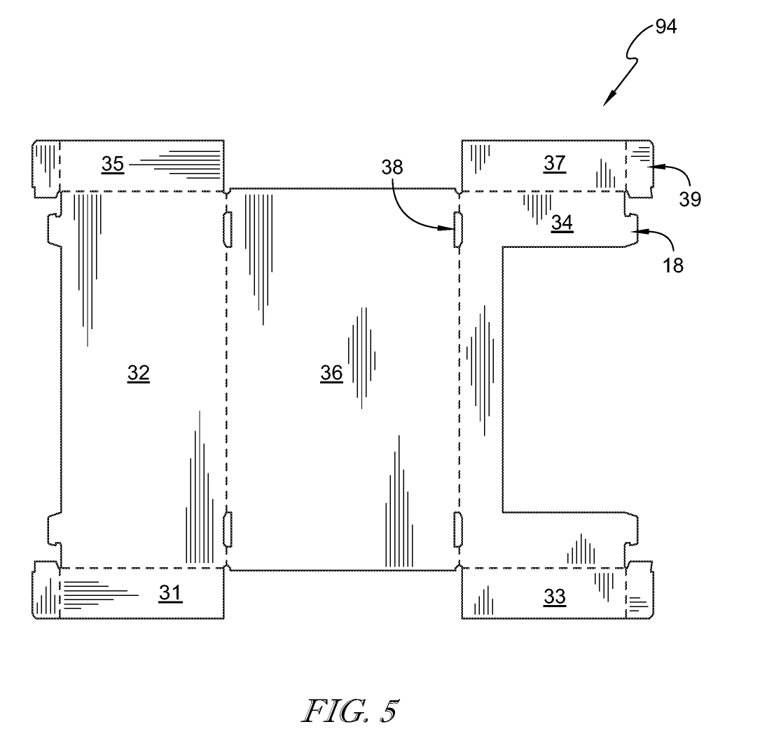

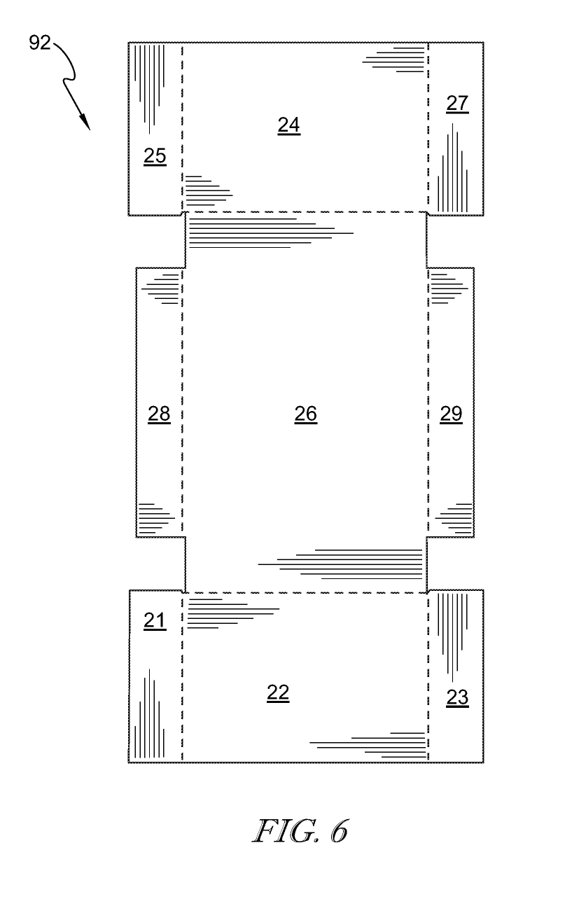

Product tray 10 is formed from a base portion 20 and a reinforcement portion 30 that attaches to base portion 20 as suggested in FIGS. 2 and 4. Base portion 20 is formed from a base blank 92 shown in FIG. 6 and reinforcement portion 30 is formed from a reinforcement blank 94 shown in FIG. 5. Base blank 92 and reinforcement blank 94 each includes a plurality of panels that fold relative to one another to erect base portion 20 and reinforcement portion 30. As shown and described herein, when making reference to a blank of material, solid lines denote a cut line where adjacent portions of material are severed from one another and dashed lines denote a fold line where portions of material are folded relative to one another. In some examples, fold lines are scored or perforated.

Base blank 92 includes a plurality of base panels 22, 24, 26 as shown in FIG. 6. The plurality of base panels includes a base-mid panel 26 and a pair of base-end panels 22, 24 coupled to opposing ends of base-mid panel 26. Base flaps 21, 23, 25, 27, 28, 29 are coupled to and extend from base panels 22, 24, 26. A first plurality of base flaps 21, 25, 28 are coupled along a first side of the plurality of base panels 22, 24, 26 and a second plurality of base flaps 23, 27, 29 are coupled along an opposing second side of the plurality of base panels 22, 24, 26. Base panels 22, 24, 26 and base flaps 21, 23, 25, 27, 28, 29 of base blank 92 are foldable relative to one another to form base portion 20.

Reinforcement blank 94 includes a plurality of reinforcement panels 32, 34, 36 as shown in FIG. 5. The plurality of reinforcement panels includes a reinforcement-mid panel 36 and a pair of reinforcement-end panels 32, 34 coupled to opposing ends of reinforcement-mid panel 36. Reinforcement flaps 31, 33, 35, 37 are coupled to and extend from reinforcement panels 32, 34, 36. A first plurality of reinforcement flaps 31, 33 are coupled along a first side of the plurality of reinforcement panels 32, 34, 36 and a second plurality of reinforcement flaps 35, 37 are coupled along an opposing second side of the plurality of reinforcement panels 32, 34, 36. Reinforcement panels 32, 34, 36 and reinforcement flaps 31, 33, 35, 37, 38, 39 of reinforcement blank 94 are foldable relative to one another to form reinforcement portion 30.

Reinforcement panels 32, 34 are formed to define alignment tabs 18. Lock tabs 39 are coupled to each reinforcement flap 31, 33, 35, 37 and engage with alignment tabs 18 when reinforcement portion 30 is erected as suggested in FIG. 1. Lock tabs 39 are configured to define a platform for supporting a product tray 10 thereon for stacking of product trays 10. Slots 38 of reinforcement portion 30 (shown in FIG. 2) are configured to receive alignment tabs 18 of a lower product tray 10 to aid in alignment of product trays 10 during stacking.

In one illustrative embodiment for erecting product tray 10, panels 22, 24, 26 and flaps 21, 23, 25, 27, 28, 29 of base blank 92 are folded relative to one another to form base portion 20 as suggested in FIGS. 2 and 4. Panel 36 of reinforcement blank 94 engages with panel 26 of base portion 20 to define floor 11. Panel 34 of reinforcement blank 94 is folded relative to panel 36 to engage with flaps 23, 27, 29 of base portion 20 to form front wall 13. Panel 32 of reinforcement blank 94 is folded relative to panel 36 to engage with flaps 21, 25, 28 of base portion 20 to form back wall 15. Flaps 31, 33 of reinforcement blank 94 are folded relative to panels 32, 34, respectively, to engage with panel 22 of base portion 20 to form side wall 17. Flaps 35, 37 of reinforcement blank 94 are folded relative to panels 32, 34, respectively, to engage with panel 24 of base portion 20 to form side wall 19. Lock tabs 39 are folded relative to flaps 31, 33, 35, 37 to engage with alignment tabs 18.

In the illustrative embodiment, base portion 20 and reinforcement portion 30 are bonded to one another, such as with adhesive, tape, or mechanical fasteners for example. In some embodiments, only sections of base portion 20 and reinforcement portion 30 are bonded to one another, such as panels 26, 36 for example. It is within the scope of the present disclosure to make product trays 10 from a variety of materials including corrugated paperboard, folding carton, solid fiber, plastic sheeting, plastic corrugated, combinations thereof, or any other suitable material. In some embodiments, the material used to form base portion 20 and reinforcement portion 30 are arranged such that grains, flutes, or other physical properties of the material are oriented at an angle to one another. For example, in one embodiment, base portion 20 is formed of a corrugated paperboard having flutes aligned to extend from panel 22 toward panel 24, and reinforcement portion 30 is formed of a corrugated paperboard having flutes aligned to extend from panel 32 toward panel 34 such that the flutes in panels 26, 36 are perpendicular to one another when product tray 10 is erected. Base portion 20 and reinforcement portion 30 combine to form product tray 10 having multi-ply walls 13, 15, 17, 19 and floor 11 that are stronger and more resistant to sagging than a tray having single-ply walls and floor. In some embodiments, base portion 20 and reinforcement portion 30 are formed from different materials.

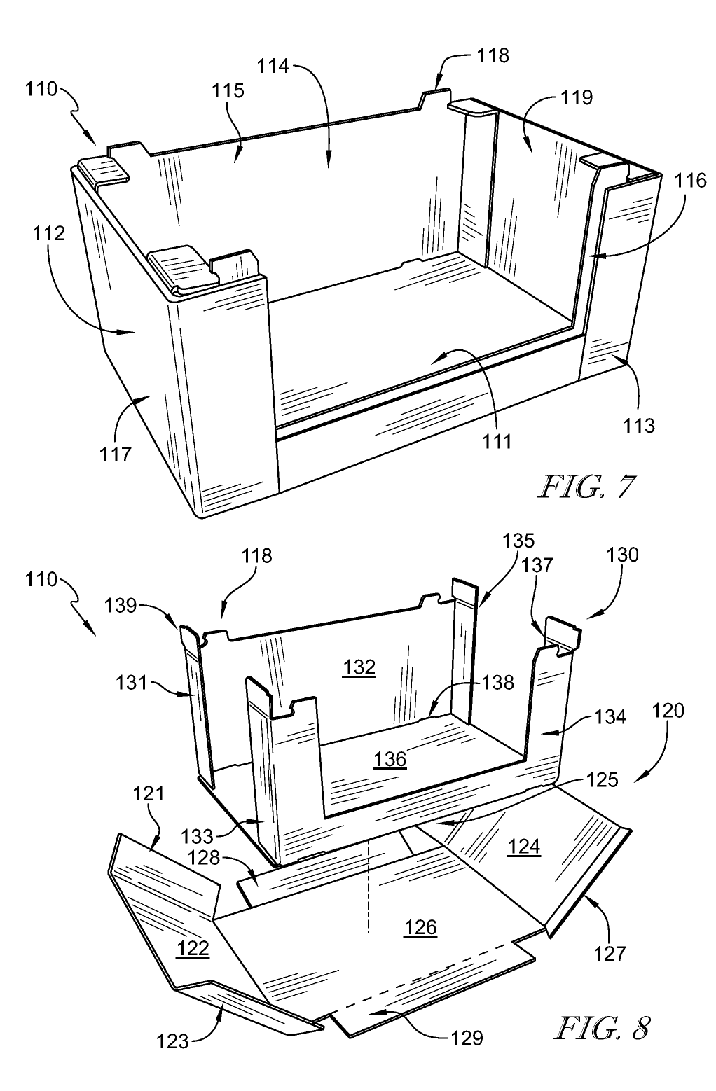

Another embodiment of a product tray 110 in accordance with the present disclosure is shown in FIG. 7. Product tray 110 includes body 112 defining a product-storage space 114 and a product-view window 116 extending through body 112 into product-storage space 114. Product-storage space 114 is configured to receive and hold product for transportation to and display in a retail location. Product-view window 116 allows a consumer at the retail location to view the product stored in product tray 110.

Body 112 of product tray 110 includes a front wall 113, a back wall 115 spaced apart from front wall 113, a pair of side walls 117, 119 extending from front wall 113 to the back wall 115, and a floor 111 as shown in FIG. 7. Front wall 113 is formed to include product-view window 116. Upper corners of product tray 110 form a platform for receiving another product tray 110 thereon and define alignment tabs 118 to aid in stacking of product trays 110.

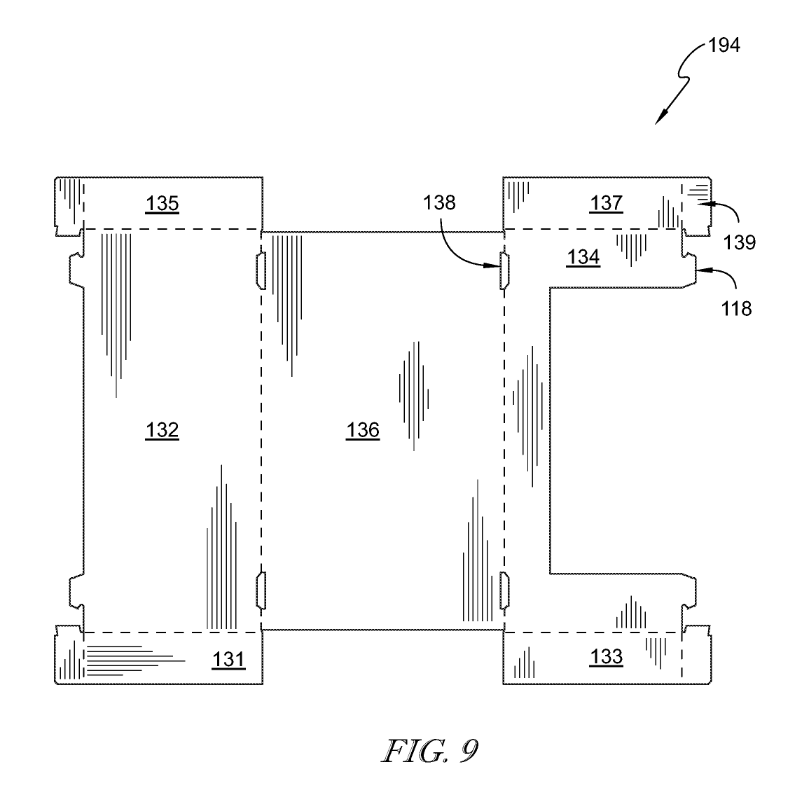

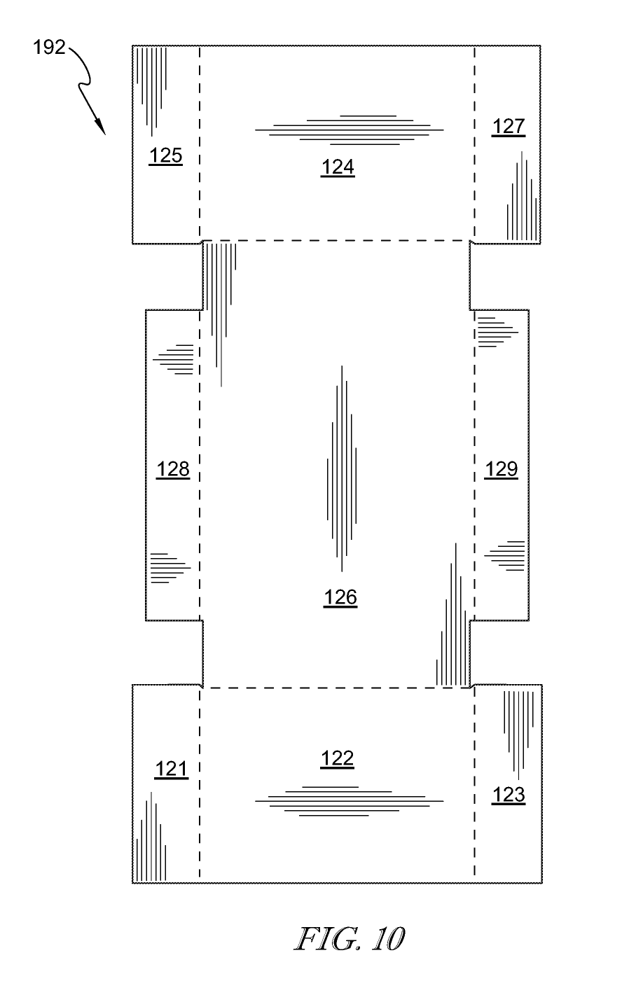

Product tray 110 is formed from a base portion 120 and a reinforcement portion 130 that attaches to base portion 120 as suggested in FIG. 8. Base portion 120 is formed from a base blank 192 shown in FIG. 10 and reinforcement portion 130 is formed from a reinforcement blank 194 shown in FIG. 9. Base blank 192 and reinforcement blank 194 each includes a plurality of panels that fold relative to one another to erect base portion 120 and reinforcement portion 130.

Base blank 192 includes base panels 122, 124, 126 as shown in FIG. 10. Base flaps 121, 123, 125, 127, 128, 129 are coupled to and extend from panels 122, 124, 126. Reinforcement blank 194 includes reinforcement panels 132, 134, 136 as shown in FIG. 9. Reinforcement flaps 131, 133, 135, 137 are coupled to and extend from panels 132, 134. Panels 132, 134 are formed to define alignment tabs 118. Lock tabs 139 are coupled to each flap 131, 133, 135, 137 and engage with alignment tabs 118 when reinforcement portion 130 is erected as suggested in FIG. 7. Lock tabs 139 are configured to define a platform for supporting a product tray 110 thereon for stacking of product trays 110. Slots 138 of reinforcement portion 130 (shown in FIG. 8) are configured to receive alignment tabs 118 of a lower product tray 110 to aid in alignment of product trays 110 during stacking.

In one illustrative embodiment for erecting product tray 110, panels 132, 134, 136 and flaps 131, 133, 135, 137 of reinforcement blank 194 are folded relative to one another to form reinforcement portion 130 as suggested in FIG. 8. Panel 126 of base blank 192 engages with panel 136 of reinforcement portion 130 to define floor 111. Panel 122 of base blank 192 is folded relative to panel 126 to engage with flaps 131, 133 of reinforcement portion 130 to form side wall 117. Panel 124 of base blank 192 is folded relative to panel 126 to engage with flaps 135, 137 of reinforcement portion 130 to form side wall 119. Flaps 121, 125, 128 of base portion 120 fold relative to panels 122, 124, 126, respectively, to engage with panel 132 of reinforcement portion 130 to form back wall 115. Flaps 123, 127, 129 of base portion 120 fold relative to panels 122, 124, 126, respectively, to engage with panel 134 of reinforcement portion 130 to form front wall 113. Lock tabs 139 are folded relative to flaps 131, 133, 135, 137 to engage with alignment tabs 118.

In the illustrative embodiment, base portion 120 and reinforcement portion 130 are bonded to one another, such as with adhesive, tape, or mechanical fasteners for example. In some embodiments, only sections of base portion 120 and reinforcement portion 130 are bonded to one another, such as panels 126, 136 for example. It is within the scope of the present disclosure to make product trays 110 from a variety of materials including corrugated paperboard, folding carton, solid fiber, plastic sheeting, plastic corrugated, combinations thereof, or any other suitable material. In some embodiments, the material used to form base portion 120 and reinforcement portion 130 are arranged such that grains, flutes, or other physical properties of the material are oriented at an angle to one another. For example, in one embodiment, base portion 120 is formed of a corrugated paperboard having flutes aligned to extend from panel 122 toward panel 124, and reinforcement portion 130 is formed of a corrugated paperboard having flutes aligned to extend from panel 132 toward panel 134 such that the flutes in panels 126, 136 are perpendicular to one another when product tray 110 is erected. Base portion 120 and reinforcement portion 130 combine to form product tray 110 having multi-ply walls 113, 115, 117, 119 and floor 111 that are stronger and more resistant to sagging than a tray having single-ply walls and floor.

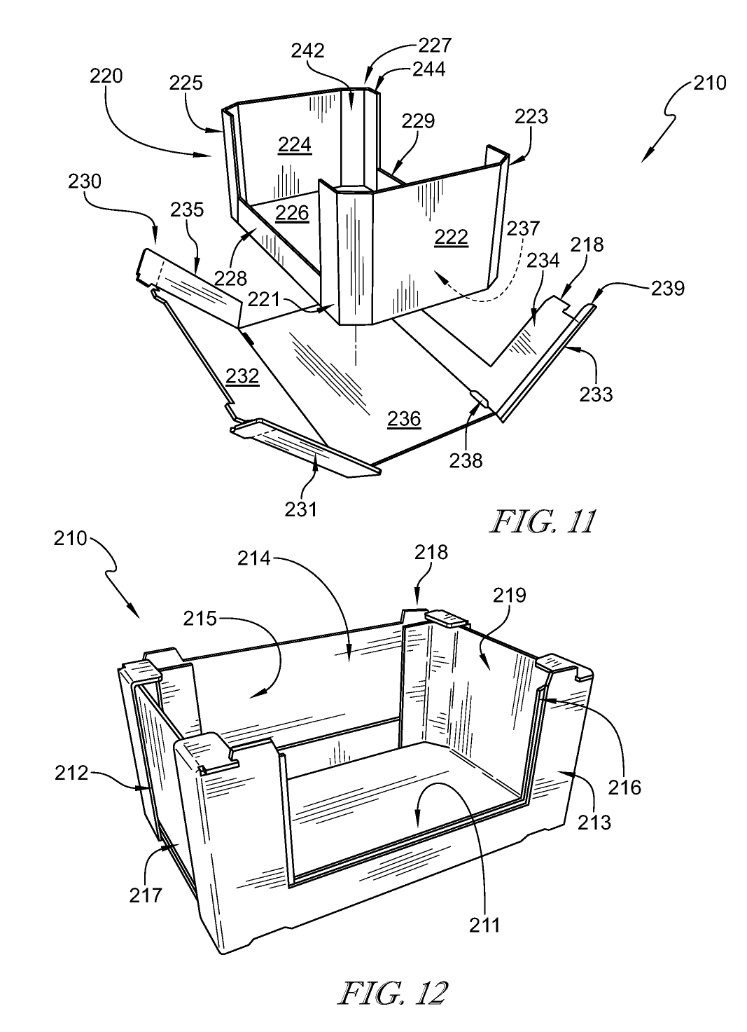

Another embodiment of a product tray 210 in accordance with the present disclosure is shown in FIGS. 11 and 12. Product tray 210 includes body 212 defining a product-storage space 214 and a product-view window 216 extending through body 212 into product-storage space 214 as shown in FIG. 12. Product-storage space 214 is configured to receive and hold product for transportation to and display in a retail location. Product-view window 216 allows a consumer at the retail location to view the product stored in product tray 210.

Body 212 of product tray 210 includes a front wall 213, a back wall 215 spaced apart from front wall 213, a pair of side walls 217, 219 extending from front wall 213 to the back wall 215, and a floor 211 as shown in FIG. 12. Front wall 213 is formed to include product-view window 216. Upper corners of product tray 210 form a platform for receiving another product tray 210 thereon and define alignment tabs 218 to aid in stacking of product trays 210.

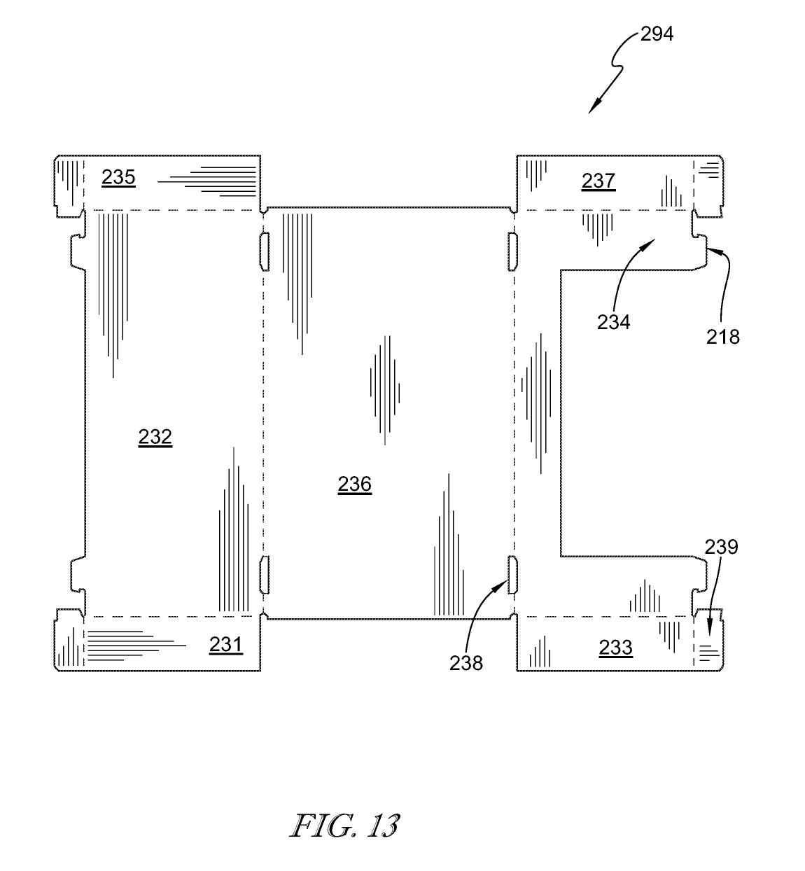

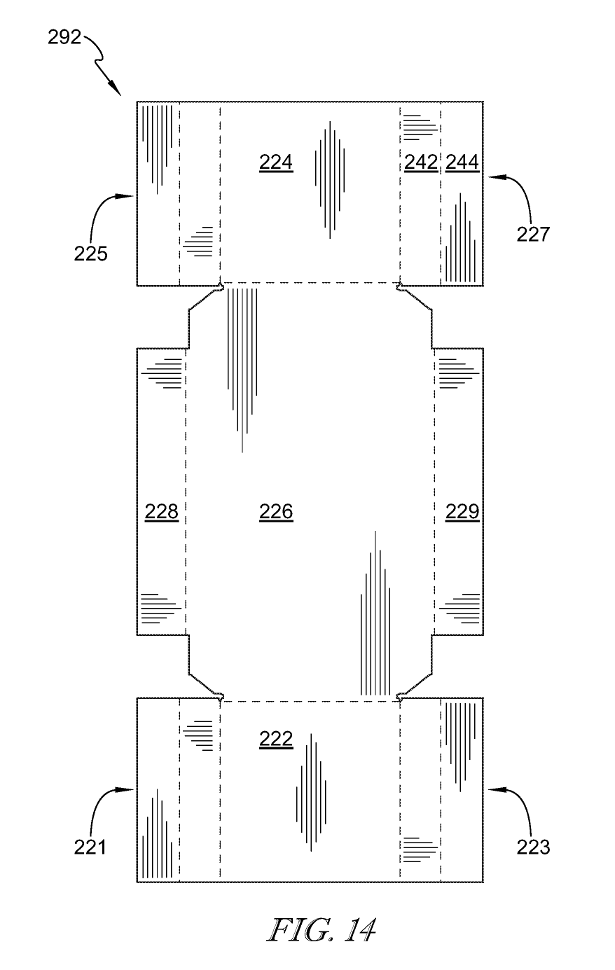

Product tray 210 is formed from a base portion 220 and a reinforcement portion 230 that attaches to base portion 220 as suggested in FIG. 11. Base portion 220 is formed from a base blank 292 shown in FIG. 14 and reinforcement portion 230 is formed from a reinforcement blank 294 shown in FIG. 13. Base blank 292 and reinforcement blank 294 each includes a plurality of panels that fold relative to one another to erect base portion 220 and reinforcement portion 230.

Base blank 292 includes base panels 222, 224, 226 as shown in FIG. 14. Base flaps 221, 223, 225, 227, 228, 229 are coupled to and extend from panels 222, 224, 226. Each of flaps 221, 223, 225, 227 includes a connector strip 242 extending from one of panels 222, 224 and an end strip 244 extending from connector strip 242. Connector strips 242 form beveled corner edges of base portion 220 when erected as suggested in FIG. 11.

Reinforcement blank 294 includes reinforcement panels 232, 234, 236 as shown in FIG. 13. Reinforcement flaps 231, 233, 235, 237 are coupled to and extend from panels 232, 234. Panels 232, 234 are formed to define alignment tabs 218. Lock tabs 239 are coupled to each flap 231, 233, 235, 237 and engage with alignment tabs 218 when reinforcement portion 230 is erected as suggested in FIG. 12. Lock tabs 239 are configured to define a platform for supporting a product tray 210 thereon for stacking of product trays 210. Slots 238 of reinforcement portion 230 (shown in FIG. 11) are configured to receive alignment tabs 218 of a lower product tray 210 to aid in alignment of product trays 210 during stacking.

In one illustrative embodiment for erecting product tray 210, panels 222, 224, 226 and flaps 221, 223, 225, 227, 228, 229 of base blank 292 are folded relative to one another to form base portion 220 as suggested in FIG. 11. Panel 236 of reinforcement portion 230 engages with panel 226 of base portion 220 to define floor 211. Panel 234 of reinforcement portion 230 is folded relative to panel 236 to engage with flaps 223, 227, 229 of base portion 220 to form front wall 213. Panel 232 of reinforcement portion 230 is folded relative to panel 236 to engage with flaps 221, 225, 228 of base portion 220 to form back wall 215. Flaps 231, 233 of reinforcement portion 230 are folded relative to panels 232, 234, respectively, to engage with panel 222 of base portion 220 to form side wall 217. Flaps 235, 237 of reinforcement portion 230 are folded relative to panels 232, 234, respectively, to engage with panel 224 of base portion 220 to form side wall 219. Lock tabs 239 are folded relative to flaps 231, 233, 235, 237 to engage with alignment tabs 218. Connector strips 242 extend from panels 232, 234 to flaps 231, 233, 235, 237 when product tray 210 is erected.

In the illustrative embodiment, base portion 220 and reinforcement portion 230 are bonded to one another, such as with adhesive, tape, or mechanical fasteners for example. In some embodiments, only sections of base portion 220 and reinforcement portion 230 are bonded to one another, such as panels 226, 236 for example. It is within the scope of the present disclosure to make product trays 210 from a variety of materials including corrugated paperboard, folding carton, solid fiber, plastic sheeting, plastic corrugated, combinations thereof, or any other suitable material. In some embodiments, the material used to form base portion 220 and reinforcement portion 230 are arranged such that grains, flutes, or other physical properties of the material are oriented at an angle to one another. For example, in one embodiment, base portion 220 is formed of a corrugated paperboard having flutes aligned to extend from panel 222 toward panel 224, and reinforcement portion 230 is formed of a corrugated paperboard having flutes aligned to extend from panel 232 toward panel 234 such that the flutes in panels 226, 236 are perpendicular to one another when product tray 210 is erected. Base portion 220 and reinforcement portion 230 combine to form product tray 210 having multi-ply walls 213, 215, 217, 219 and floor 211 that are stronger and more resistant to sagging than a tray having single-ply walls and floor.

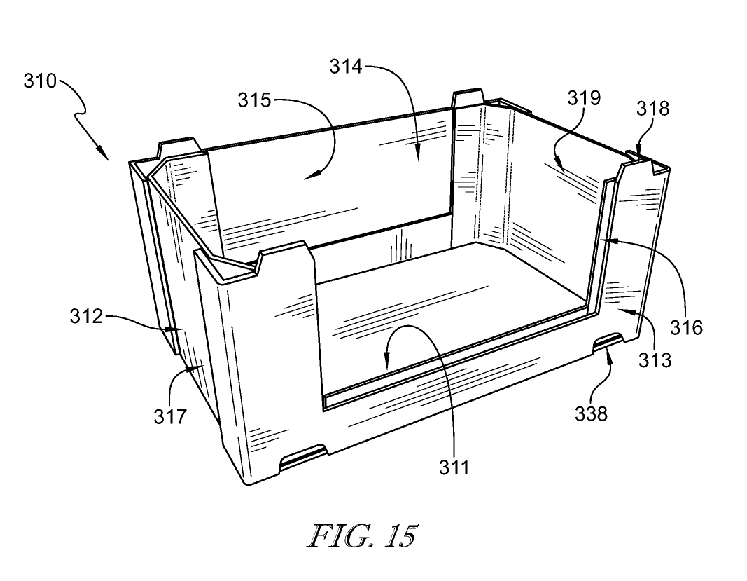

Another embodiment of a product tray 310 in accordance with the present disclosure is shown in FIG. 15. Product tray 310 includes body 312 defining a product-storage space 314 and a product-view window 316 extending through body 312 into product-storage space 314. Product-storage space 314 is configured to receive and hold product for transportation to and display in a retail location. Product-view window 316 allows a consumer at the retail location to view the product stored in product tray 310.

Body 312 of product tray 310 includes a front wall 313, a back wall 315 spaced apart from front wall 313, a pair of side walls 317, 319 extending from front wall 313 to the back wall 315, and a floor 311 as shown in FIG. 15. Front wall 313 is formed to include product-view window 316. Upper corners of product tray 310 form a platform for receiving another product tray 310 thereon and define alignment tabs 318 to aid in stacking of product trays 310.

Product tray 310 is similar to product tray 210 shown in FIGS. 11 and 12, with one difference being that product tray 310 does not include lock tabs 239. Notches 338 are formed into front wall 313 and back wall 315 and configured to receive alignment tabs 318 of a lower product tray 310 to aid in alignment of product trays 310 during stacking. Upper corners of product tray 310 form a platform for receiving another product tray 310 thereon and define alignment tabs 318 to aid in stacking of product trays 310.

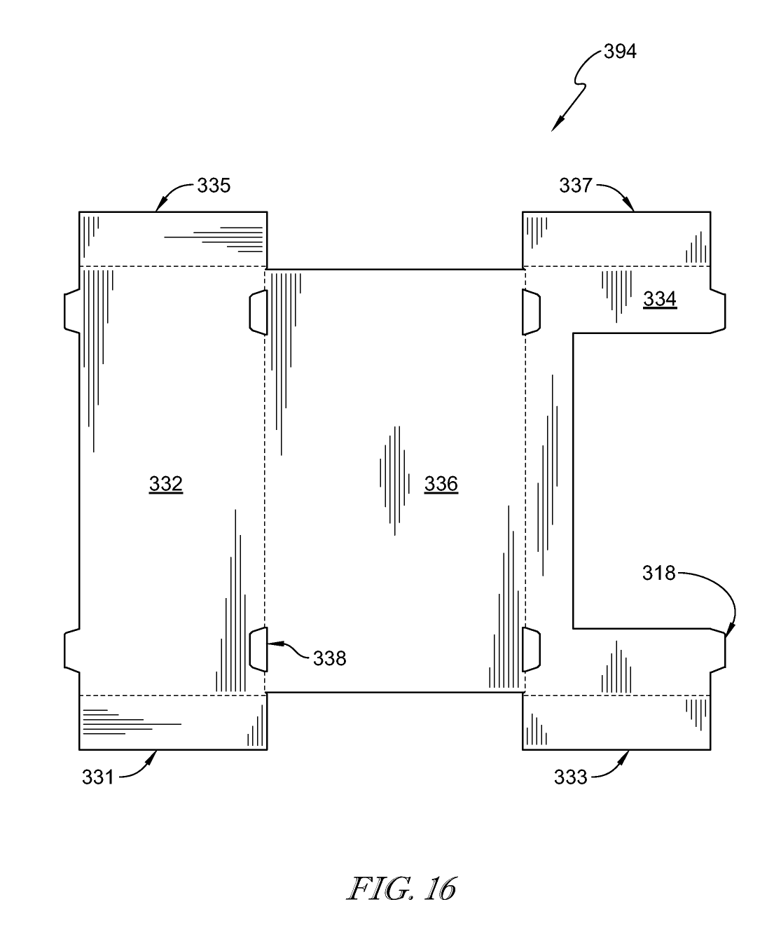

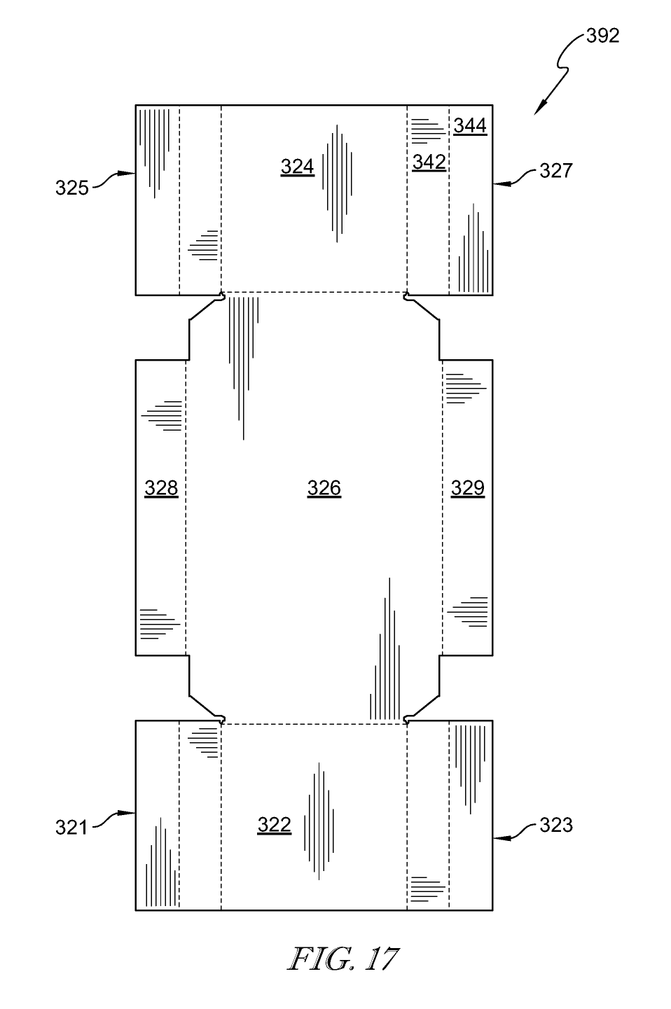

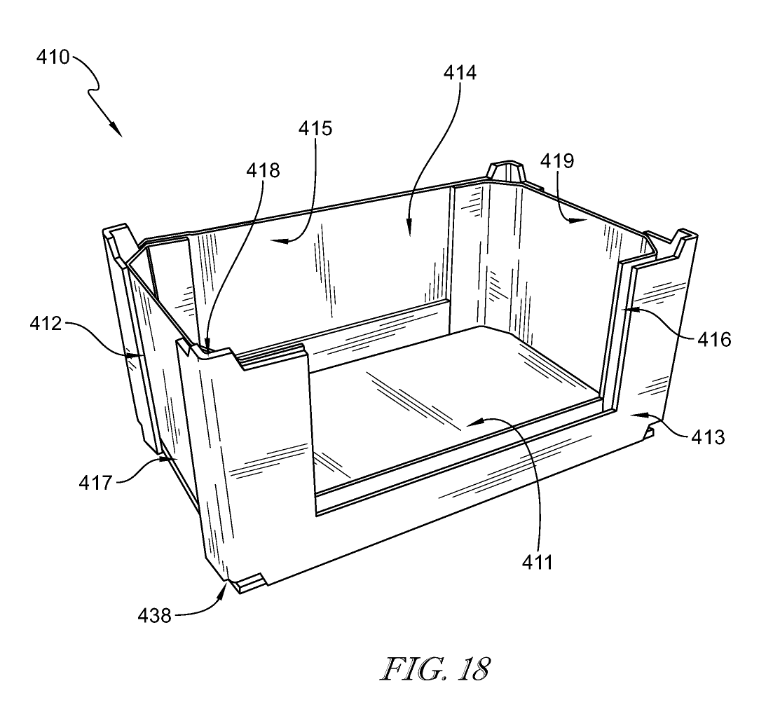

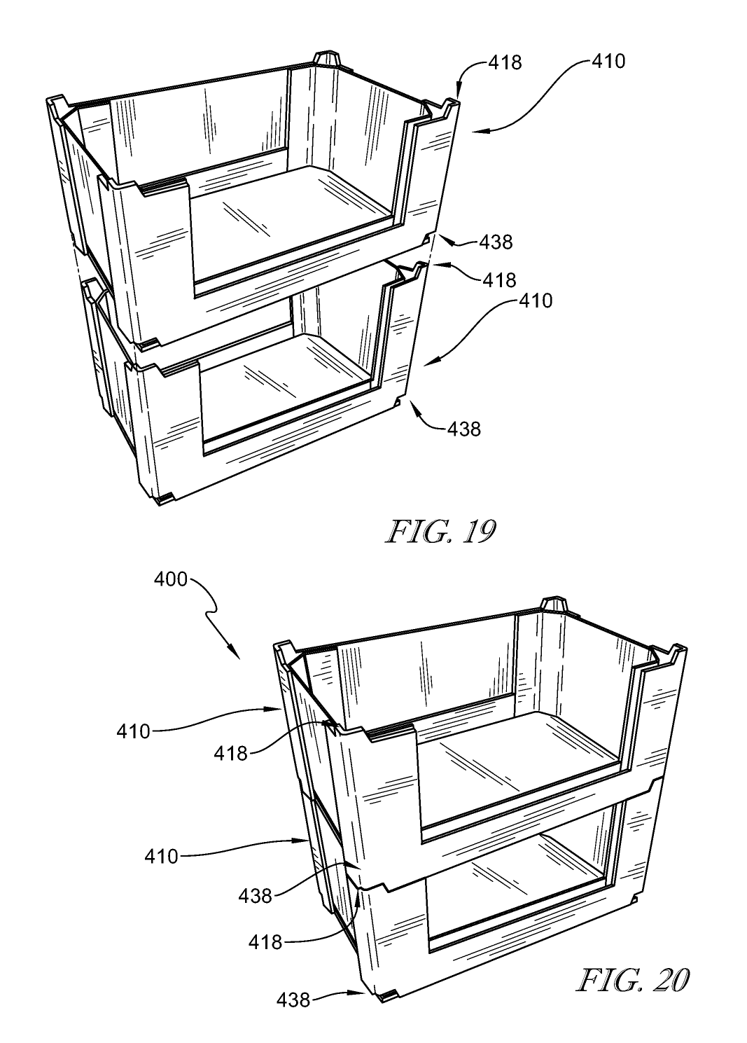

Product tray 310 is formed from a base portion and a reinforcement portion that attaches to the base portion as suggested in FIG. 15. The base portion is formed from a base blank 392 shown in FIG. 17 and the reinforcement portion is formed from a reinforcement blank 394 shown in FIG. 16. Base blank 392 and reinforcement blank 394 each includes a plurality of panels that fold relative to one another to erect the base portion and the reinforcement portion.

Base blank 392 includes base panels 322, 324, 326 as shown in FIG. 17. Base flaps 321, 323, 325, 327, 328, 329 are coupled to and extend from panels 322, 324, 326. Each of flaps 321, 323, 325, 327 includes a connector strip 342 extending from one of panels 322, 324 and an end strip 344 extending from connector strip 342. Connector strips 342 form beveled corner edges of the base portion when erected as suggested in FIG. 15.

Reinforcement blank 394 includes reinforcement panels 332, 334, 336 as shown in FIG. 16. Reinforcement flaps 331, 333, 335, 337 are coupled to and extend from panels 332, 334. Panels 332, 334 are formed to define alignment tabs 318. Slots 338 of the reinforcement portion (shown in FIG. 15) are configured to receive alignment tabs 318 of a lower product tray 310 to aid in alignment of product trays 310 during stacking.

In one illustrative embodiment for erecting product tray 310, panels 322, 324, 326 and flaps 321, 323, 325, 327, 328, 329 of base blank 392 are folded relative to one another to form the base portion. Panel 336 of the reinforcement blank 394 engages with panel 326 of the base portion to define floor 311. Panel 334 of reinforcement blank 394 is folded relative to panel 336 to engage with flaps 323, 327, 329 of the base portion to form front wall 313. Panel 332 of reinforcement 394 is folded relative to panel 336 to engage with flaps 321, 325, 328 of the base portion to form back wall 315. Flaps 331, 333 of reinforcement blank 394 are folded relative to panels 332, 334, respectively, to engage with panel 322 of the base portion to form side wall 317. Flaps 335, 337 of reinforcement blank 394 are folded relative to panels 332, 334, respectively, to engage with panel 324 of the base portion to form side wall 319. Connector strips 342 extend from panels 332, 334 to flaps 331, 333, 335, 337 when product tray 310 is erected.

In the illustrative embodiment, the base portion and the reinforcement portion of product tray 310 are bonded to one another, such as with adhesive, tape, or mechanical fasteners for example. In some embodiments, only sections of the base portion and the reinforcement portion are bonded to one another, such as panels 326, 336 for example. It is within the scope of the present disclosure to make product trays 310 from a variety of materials including corrugated paperboard, folding carton, solid fiber, plastic sheeting, plastic corrugated, combinations thereof, or any other suitable material. In some embodiments, the material used to form the base portion and the reinforcement portion are arranged such that grains, flutes, or other physical properties of the material are oriented at an angle to one another. For example, in one embodiment, the base portion is formed of a corrugated paperboard having flutes aligned to extend from panel 322 toward panel 324, and the reinforcement portion is formed of a corrugated paperboard having flutes aligned to extend from panel 332 toward panel 334 such that the flutes in panels 326, 336 are perpendicular to one another when product tray 310 is erected. The base portion and the reinforcement portion combine to form product tray 310 having multi-ply walls 313, 315, 317, 319 and floor 311 that are stronger and more resistant to sagging than a tray having single-ply walls and floor.

Another embodiment of a product tray 410 in accordance with the present disclosure is shown in FIG. 18. Product tray 410 includes body 412 defining a product-storage space 414 and a product-view window 416 extending through body 412 into product-storage space 414. Product-storage space 414 is configured to receive and hold product for transportation to and display in a retail location. Product-view window 416 allows a consumer at the retail location to view the product stored in product tray 410.

Body 412 of product tray 410 includes a front wall 413, a back wall 415 spaced apart from front wall 413, a pair of side walls 417, 419 extending from front wall 413 to the back wall 415, and a floor 411 as shown in FIG. 18. Front wall 413 is formed to include product-view window 416. Upper corners of product tray 410 form a platform for receiving another product tray 410 thereon and define alignment tabs 418 to aid in stacking of product trays 410.

Product tray 410 is similar to product tray 210 shown in FIGS. 11 and 12, with one difference being that product tray 410 does not include lock tabs 239. Notches 438 are formed into lower corners of product tray 410 and configured to receive alignment tabs 418 of a lower product tray 410 to aid in alignment of product trays 410 during stacking as suggested in FIGS. 19 and 20. An upper product tray 410 rests on a lower product tray 410 to form a stack 400 of product trays 410.

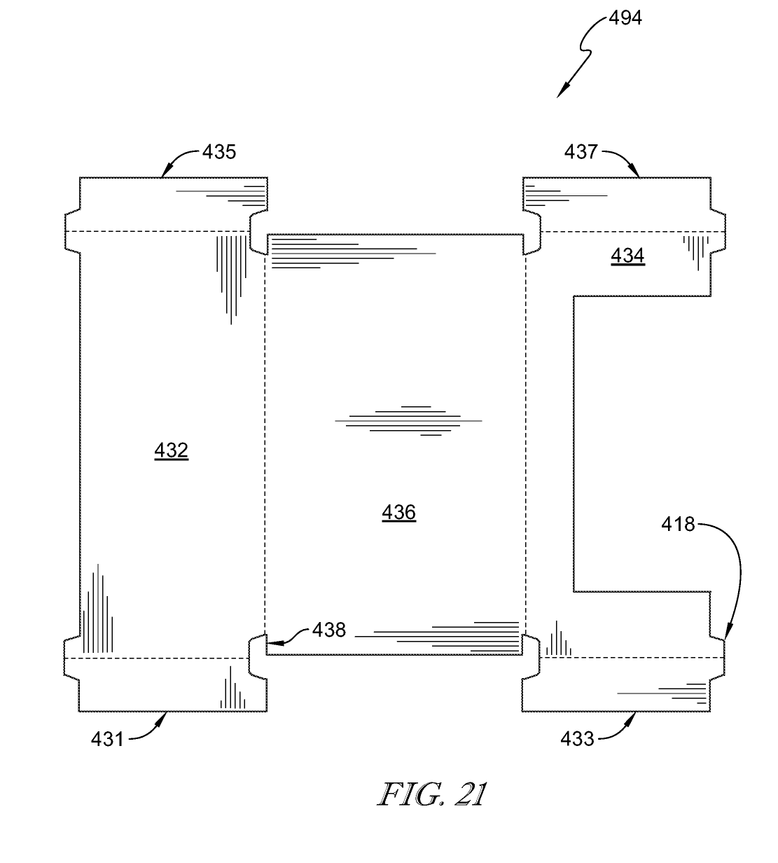

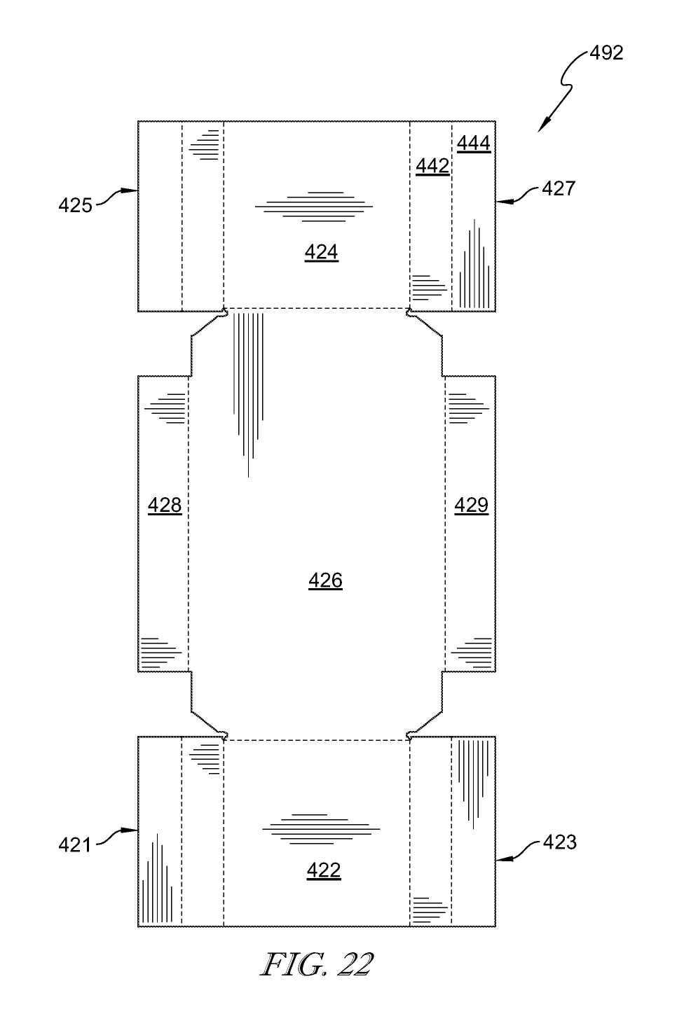

Product tray 410 is formed from a base portion and a reinforcement portion that attaches to the base portion as suggested in FIG. 18. The base portion is formed from a base blank 492 shown in FIG. 22 and the reinforcement portion is formed from a reinforcement blank 494 shown in FIG. 21. Base blank 492 and reinforcement blank 494 each includes a plurality of panels that fold relative to one another to erect the base portion and the reinforcement portion.

Base blank 492 includes base panels 422, 424, 426 as shown in FIG. 22. Base flaps 421, 423, 425, 427, 428, 429 are coupled to and extend from panels 422, 424, 426. Each of flaps 421, 423, 425, 427 includes a connector strip 442 extending from one of panels 422, 424 and an end strip 444 extending from connector strip 442. Connector strips 442 form beveled corner edges of the base portion when erected as suggested in FIG. 18.

Reinforcement blank 494 includes reinforcement panels 432, 434, 436 as shown in FIG. 21. Reinforcement flaps 431, 433, 435, 437 are coupled to and extend from panels 432, 434. Panels 432, 434 are formed to define alignment tabs 418. Slots 438 of the reinforcement portion are configured to receive alignment tabs 418 of a lower product tray 410 to aid in alignment of product trays 410 during stacking as suggested in FIGS. 19 and 20.

In one illustrative embodiment for erecting product tray 410, panels 422, 424, 426 and flaps 421, 423, 425, 427, 428, 429 of base blank 492 are folded relative to one another to form the base portion. Panel 436 of the reinforcement blank 494 engages with panel 426 of the base portion to define floor 411. Panel 434 of reinforcement blank 494 is folded relative to panel 436 to engage with flaps 423, 427, 429 of the base portion to form front wall 413. Panel 432 of reinforcement 494 is folded relative to panel 436 to engage with flaps 421, 425, 428 of the base portion to form back wall 415. Flaps 431, 433 of reinforcement blank 494 are folded relative to panels 432, 434, respectively, to engage with panel 422 of the base portion to form side wall 417. Flaps 435, 437 of reinforcement blank 494 are folded relative to panels 432, 434, respectively, to engage with panel 424 of the base portion to form side wall 419. Connector strips 442 extend from panels 432, 434 to flaps 431, 433, 435, 437 when product tray 410 is erected.

In the illustrative embodiment, the base portion and the reinforcement portion of product tray 410 are bonded to one another, such as with adhesive, tape, or mechanical fasteners for example. In some embodiments, only sections of the base portion and the reinforcement portion are bonded to one another, such as panels 426, 436 for example. It is within the scope of the present disclosure to make product trays 410 from a variety of materials including corrugated paperboard, folding carton, solid fiber, plastic sheeting, plastic corrugated, combinations thereof, or any other suitable material. In some embodiments, the material used to form the base portion and the reinforcement portion are arranged such that grains, flutes, or other physical properties of the material are oriented at an angle to one another. For example, in one embodiment, the base portion is formed of a corrugated paperboard having flutes aligned to extend from panel 422 toward panel 424, and the reinforcement portion is formed of a corrugated paperboard having flutes aligned to extend from panel 432 toward panel 434 such that the flutes in panels 426, 436 are perpendicular to one another when product tray 410 is erected. The base portion and the reinforcement portion combine to form product tray 410 having multi-ply walls 413, 415, 417, 419 and floor 411 that are stronger and more resistant to sagging than a tray having single-ply walls and floor.

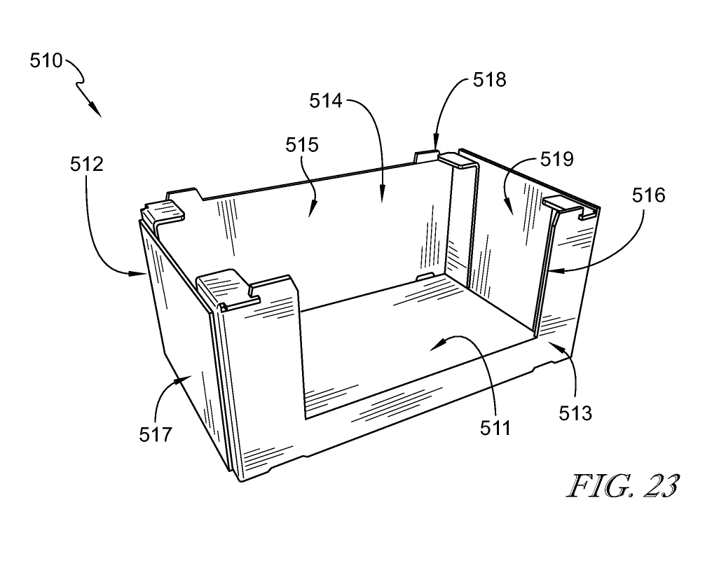

Another embodiment of a product tray 510 in accordance with the present disclosure is shown in FIG. 23. Product tray 510 includes body 512 defining a product-storage space 514 and a product-view window 516 extending through body 512 into product-storage space 514. Product-storage space 514 is configured to receive and hold product for transportation to and display in a retail location. Product-view window 516 allows a consumer at the retail location to view the product stored in product tray 510.

Body 512 of product tray 510 includes a front wall 513, a back wall 515 spaced apart from front wall 513, a pair of side walls 517, 519 extending from front wall 513 to the back wall 515, and a floor 511 as shown in FIG. 23. Front wall 513 is formed to include product-view window 516. Upper corners of product tray 510 form a platform for receiving another product tray 510 thereon and define alignment tabs 118 to aid in stacking of product trays 510.

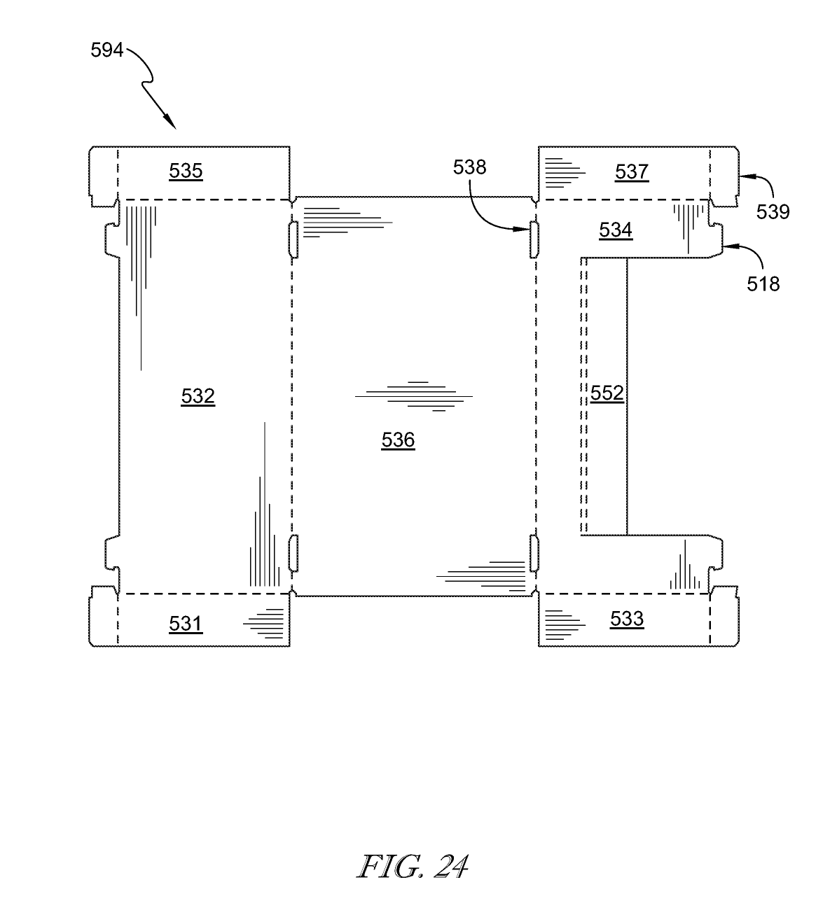

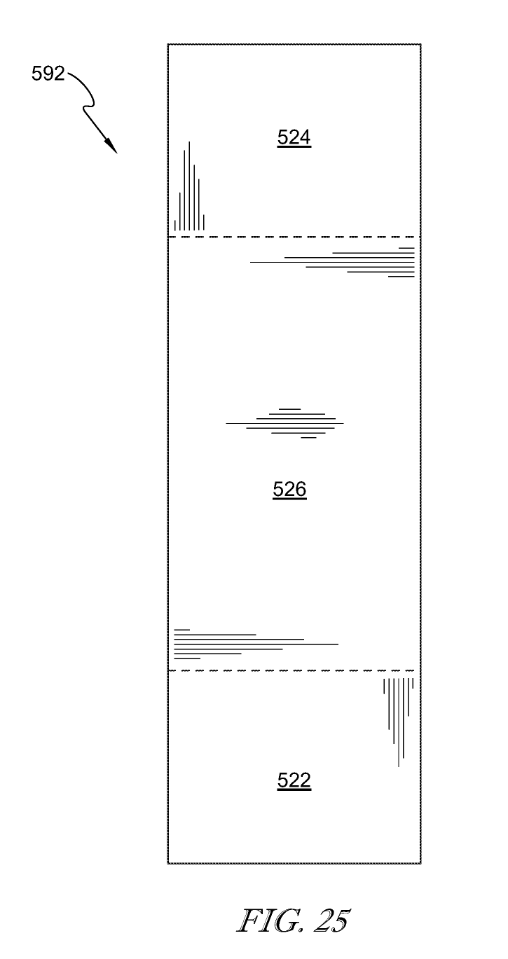

Product tray 510 is formed from a base portion and a reinforcement portion that attaches to the base portion. The base portion is formed from a base blank 592 shown in FIG. 25 and the reinforcement portion is formed from a reinforcement blank 594 shown in FIG. 24. Base blank 592 and reinforcement blank 594 each includes a plurality of panels that fold relative to one another to erect the base portion and the reinforcement portion.

Base blank 592 includes base panels 522, 524, 526 as shown in FIG. 25. Reinforcement blank 594 includes reinforcement panels 532, 534, 536 as shown in FIG. 24. Reinforcement flaps 531, 533, 535, 537, 552 are coupled to and extend from panels 532, 534. Panels 532, 534 are formed to define alignment tabs 518. Lock tabs 539 are coupled to each flap 531, 533, 535, 537 and engage with alignment tabs 518 when the reinforcement portion is erected. Lock tabs 539 are configured to define a platform for supporting a product tray 510 thereon for stacking of product trays 510. Slots 538 of the reinforcement blank 594 (shown in FIG. 24) are configured to receive alignment tabs 518 of a lower product tray 510 to aid in alignment of product trays 510 during stacking.

In one illustrative embodiment for erecting product tray 510, panels 532, 534, 536 and flaps 531, 533, 535, 537, 552 of reinforcement blank 594 are folded relative to one another to form the reinforcement portion. Panel 526 of base blank 592 engages with panel 536 of the reinforcement portion to define floor 511. Panel 522 of base blank 592 is folded relative to panel 526 to engage with flaps 531, 533 of the reinforcement portion to form side wall 517. Panel 524 of base blank 592 is folded relative to panel 526 to engage with flaps 535, 537 of the reinforcement portion to form side wall 519. Panel 532 of the reinforcement portion defines back wall 515 and panel 534 defines front wall 513. Flap 552 reverse-folds relative to panel 534 and bonds with panel 534 to strengthen panel 534 between side walls 517, 519. Lock tabs 539 are folded relative to flaps 531, 533, 535, 537 to engage with alignment tabs 518.

In the illustrative embodiment, the base portion and the reinforcement portion of product tray 510 are bonded to one another, such as with adhesive, tape, or mechanical fasteners for example. In some embodiments, only sections of the base portion and the reinforcement portion are bonded to one another, such as panels 526, 536 for example. It is within the scope of the present disclosure to make product trays 510 from a variety of materials including corrugated paperboard, folding carton, solid fiber, plastic sheeting, plastic corrugated, combinations thereof, or any other suitable material. In some embodiments, the material used to form the base portion and the reinforcement portion are arranged such that grains, flutes, or other physical properties of the material are oriented at an angle to one another. For example, in one embodiment, the base portion is formed of a corrugated paperboard having flutes aligned to extend from panel 522 toward panel 524, and the reinforcement portion is formed of a corrugated paperboard having flutes aligned to extend from panel 532 toward panel 534 such that the flutes in panels 526, 536 are perpendicular to one another when product tray 510 is erected. The base portion and the reinforcement portion combine to form product tray 510 having multi-ply walls 513, 517, 519 and floor 511 that are stronger and more resistant to sagging than a tray having single-ply walls and floor.

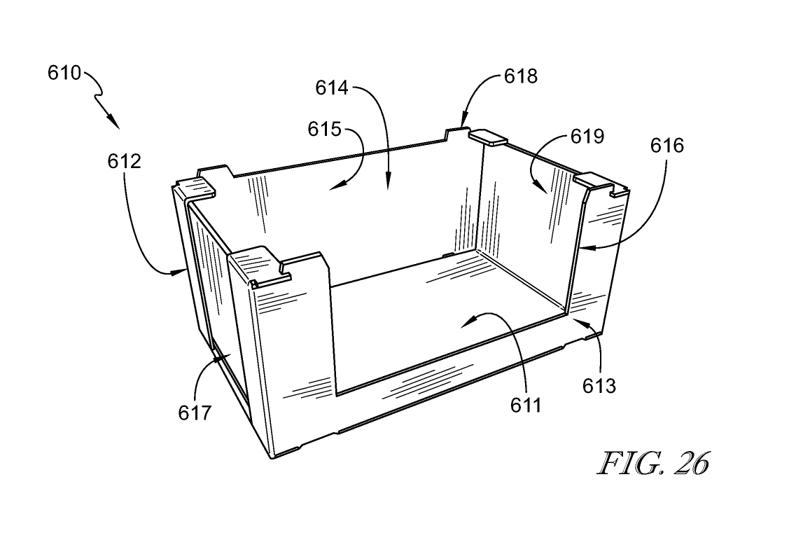

Another embodiment of a product tray 610 in accordance with the present disclosure is shown in FIG. 26. Product tray 610 includes body 612 defining a product-storage space 614 and a product-view window 616 extending through body 612 into product-storage space 614. Product-storage space 614 is configured to receive and hold product for transportation to and display in a retail location. Product-view window 616 allows a consumer at the retail location to view the product stored in product tray 610.

Body 612 of product tray 610 includes a front wall 613, a back wall 615 spaced apart from front wall 613, a pair of side walls 617, 619 extending from front wall 613 to the back wall 615, and a floor 611 as shown in FIG. 26. Front wall 613 is formed to include product-view window 616. Upper corners of product tray 610 form a platform for receiving another product tray 610 thereon and define alignment tabs 618 to aid in stacking of product trays 610.

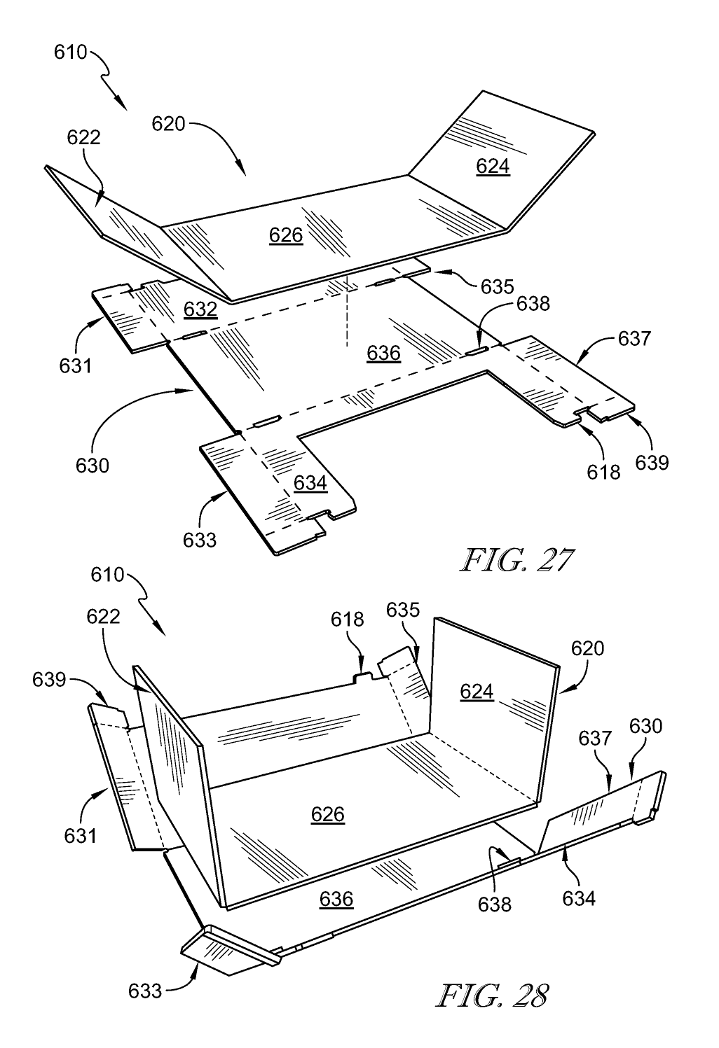

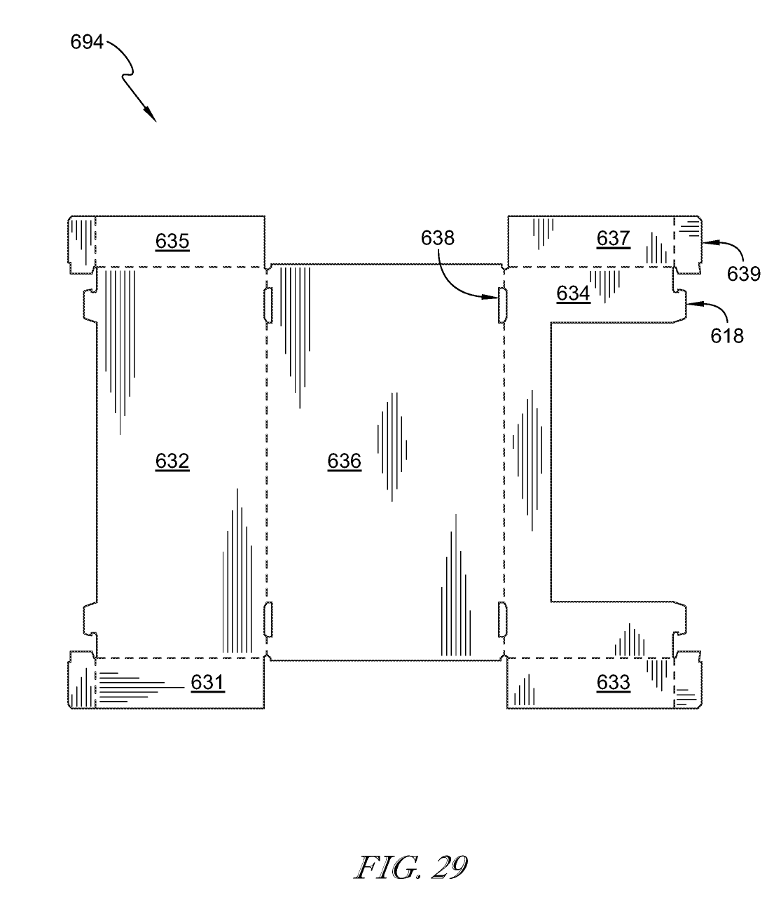

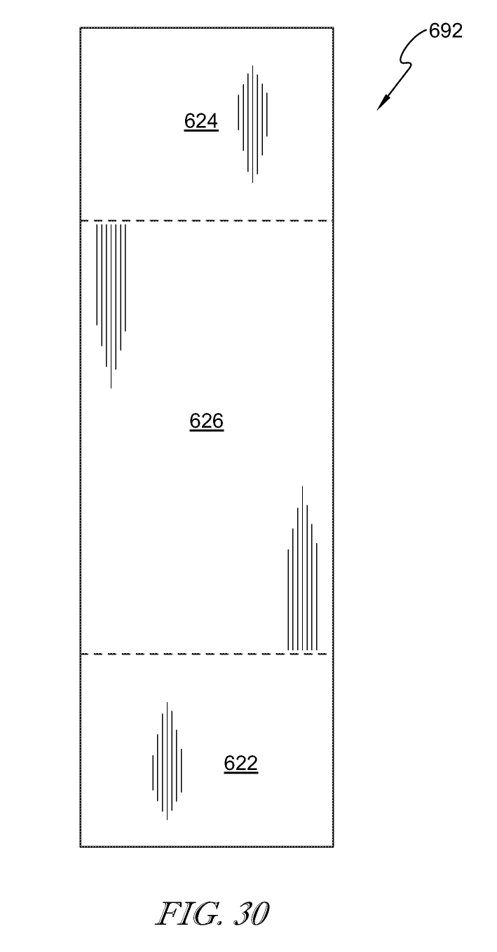

Product tray 610 is formed from a base portion 620 and a reinforcement portion 630 that attaches to base portion 620 as suggested in FIGS. 27 and 28. Base portion 620 is formed from a base blank 692 shown in FIG. 30 and reinforcement portion 630 is formed from a reinforcement blank 694 shown in FIG. 29. Base blank 692 and reinforcement blank 694 each includes a plurality of panels that fold relative to one another to erect base portion 620 and reinforcement portion 630.

Base blank 692 includes base panels 622, 624, 626 as shown in FIG. 30. Reinforcement blank 694 includes reinforcement panels 632, 634, 636 as shown in FIG. 29. Reinforcement flaps 631, 633, 635, 637 are coupled to and extend from panels 632, 634. Panels 632, 634 are formed to define alignment tabs 618. Lock tabs 639 are coupled to each flap 631, 633, 635, 637 and engage with alignment tabs 618 when reinforcement portion 630 is erected as suggested in FIG. 26. Lock tabs 639 are configured to define a platform for supporting a product tray 610 thereon for stacking of product trays 610. Slots 638 of reinforcement portion 630 (shown in FIG. 27) are configured to receive alignment tabs 618 of a lower product tray 610 to aid in alignment of product trays 610 during stacking.

In one illustrative embodiment for erecting product tray 610, panels 622, 624, 626 of base portion 620 are folded relative to one another to form base portion 620 as suggested in FIGS. 27 and 28. Panel 636 of reinforcement portion 630 engages with panel 626 of base portion 620 to define floor 611. Panel 634 of reinforcement portion 630 is folded relative to panel 636 to form front wall 613. Panel 632 of reinforcement portion 630 is folded relative to panel 636 to form back wall 615. Flaps 631, 633 of reinforcement portion 630 are folded relative to panels 632, 634, respectively, to engage with panel 622 of base portion 620 to form side wall 617. Flaps 635, 637 of reinforcement portion 630 are folded relative to panels 632, 634, respectively, to engage with panel 624 of base portion 620 to form side wall 619. Lock tabs 639 are folded relative to flaps 631, 633, 635, 637 to engage with alignment tabs 618.

In the illustrative embodiment, base portion 620 and reinforcement portion 630 are bonded to one another, such as with adhesive, tape, or mechanical fasteners for example. In some embodiments, only sections of base portion 620 and reinforcement portion 630 are bonded to one another, such as panels 626, 636 for example. It is within the scope of the present disclosure to make product trays 610 from a variety of materials including corrugated paperboard, folding carton, solid fiber, plastic sheeting, plastic corrugated, combinations thereof, or any other suitable material. In some embodiments, the material used to form base portion 620 and reinforcement portion 630 are arranged such that grains, flutes, or other physical properties of the material are oriented at an angle to one another. For example, in one embodiment, base portion 620 is formed of a corrugated paperboard having flutes aligned to extend from panel 622 toward panel 624, and reinforcement portion 630 is formed of a corrugated paperboard having flutes aligned to extend from panel 632 toward panel 634 such that the flutes in panels 626, 636 are perpendicular to one another when product tray 610 is erected. Base portion 620 and reinforcement portion 630 combine to form product tray 610 having multi-ply walls 617, 619 and floor 611 that are stronger and more resistant to sagging than a tray having single-ply walls and floor.

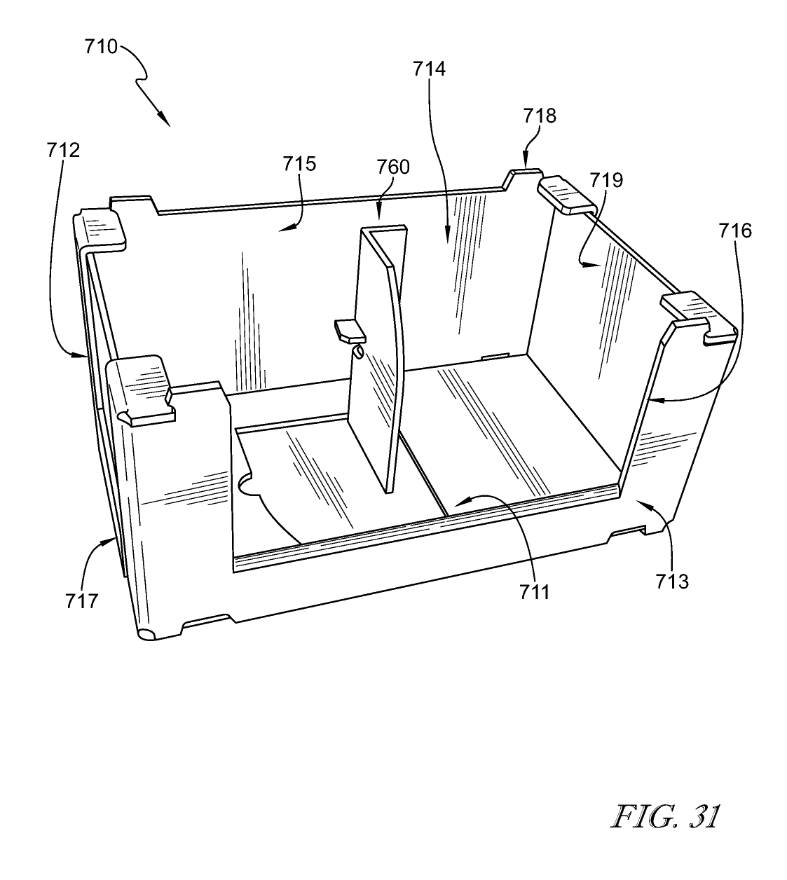

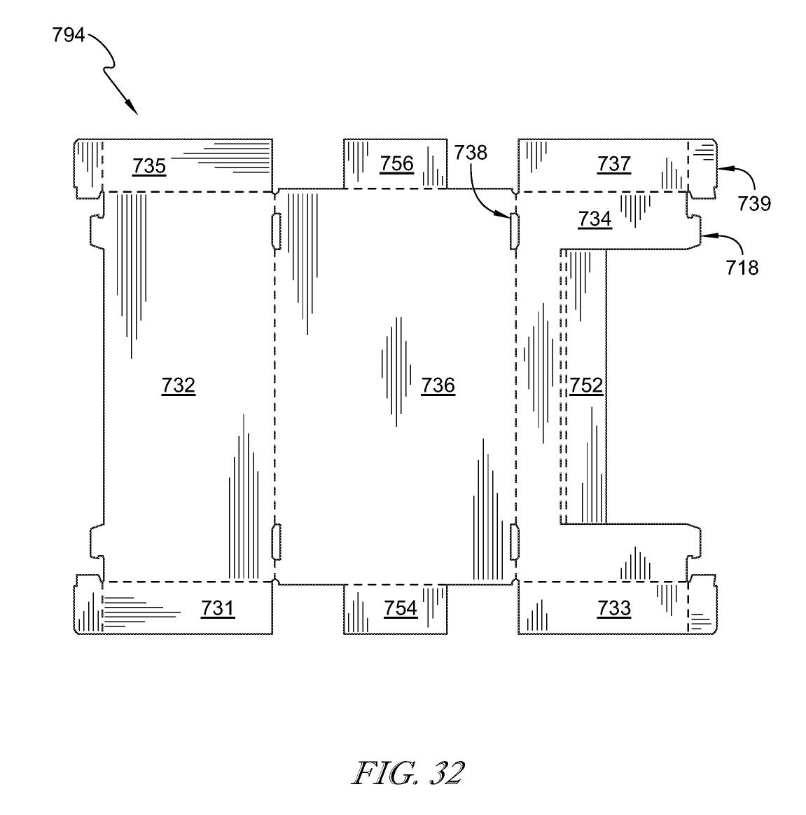

Another embodiment of a product tray 710 in accordance with the present disclosure is shown in FIG. 31. Product tray 710 includes body 712 defining a product-storage space 714 and a product-view window 716 extending through body 712 into product-storage space 714. Product-storage space 714 is configured to receive and hold product for transportation to and display in a retail location. Product-view window 716 allows a consumer at the retail location to view the product stored in product tray 710.

Body 712 of product tray 710 includes a front wall 713, a back wall 715 spaced apart from front wall 713, a pair of side walls 717, 719 extending from front wall 713 to the back wall 715, and a floor 711 as shown in FIG. 31. Front wall 713 is formed to include product-view window 716. Upper corners of product tray 710 form a platform for receiving another product tray 710 thereon and define alignment tabs 718 to aid in stacking of product trays 710. In the illustrative embodiment, a product divider 760 is formed in floor 711 and optionally extended into an upright position, such as shown in FIG. 31, to divide product-storage space 714. In some embodiments, graphics or other printed indicia are applied to product divider 760.

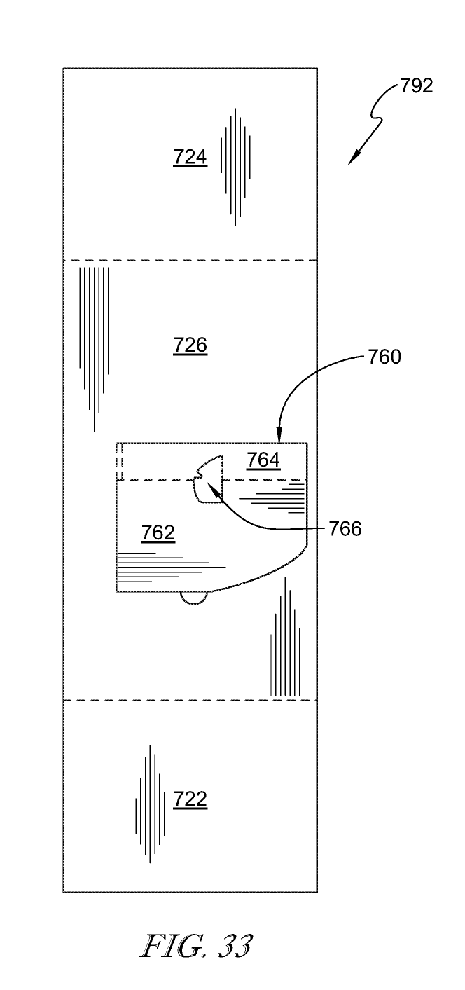

Product tray 710 is formed from a base portion and a reinforcement portion that attaches to the base portion. The base portion is formed from a base blank 792 shown in FIG. 33 and the reinforcement portion is formed from a reinforcement blank 994 shown in FIG. 32. Base blank 792 and reinforcement blank 794 each includes a plurality of panels that fold relative to one another to erect the base portion and the reinforcement portion.

Base blank 792 includes base panels 722, 724, 726 as shown in FIG. 33. Panel 726 is formed to define product divider 760. Product divider 760 includes a divider panel 762, a support panel 764, and a lock tab 766. Divider panel 762 is foldably coupled to support panel 764, and support panel 746 is foldably coupled to panel 726. To erect product divider 760, support panel 764 is folded relative to panel 726, and divider panel 762 is folded relative to support panel 764. Lock tab 766 is foldably coupled to support panel 764, and folds relative to support panel 764 to engage with divider panel 762 and hold product divider 760 in an erected position.

Reinforcement blank 794 includes reinforcement panels 732, 734, 736 as shown in FIG. 32. Reinforcement flaps 731, 733, 735, 737, 752, 754, 756 are coupled to and extend from panels 732, 734, 736. Panels 732, 734 are formed to define alignment tabs 718. Lock tabs 739 are coupled to each flap 731, 733, 735, 737 and engage with alignment tabs 718 when product tray 710 is erected as suggested in FIG. 31. Lock tabs 739 are configured to define a platform for supporting a product tray 710 thereon for stacking of product trays 710. Slots 738 of reinforcement portion 730 (shown in FIG. 32) are configured to receive alignment tabs 718 of a lower product tray 710 to aid in alignment of product trays 710 during stacking.

In one illustrative embodiment for erecting product tray 710, panels 722, 724, 726 of the base portion are folded relative to one another. Panel 736 of the reinforcement portion engages with panel 726 of the base portion to define floor 711. Panel 734 of the reinforcement portion 730 is folded relative to panel 736 to form front wall 713. Flap 752 reverse-folds relative to panel 734 and bonds with panel 734 to strengthen panel 734 between side walls 717, 719. Panel 732 of the reinforcement portion is folded relative to panel 736 to form back wall 715. Flaps 731, 733, 754 of the reinforcement portion are folded relative to panels 732, 734, 736, respectively, to engage with panel 722 of the base portion to form side wall 717. Flaps 735, 737, 756 of the reinforcement portion are folded relative to panels 732, 734, 736, respectively, to engage with panel 724 of the base portion to form side wall 719. Lock tabs 739 are folded relative to flaps 731, 733, 735, 737 to engage with alignment tabs 718. Product divider 760 is optionally erected as described above.

In the illustrative embodiment, the base portion and the reinforcement portion of product tray 710 are bonded to one another, such as with adhesive, tape, or mechanical fasteners for example. In some embodiments, only sections of the base portion and the reinforcement portion are bonded to one another, such as portions of panels 726, 736 surrounding product divider 760 for example. It is within the scope of the present disclosure to make product trays 710 from a variety of materials including corrugated paperboard, folding carton, solid fiber, plastic sheeting, plastic corrugated, combinations thereof, or any other suitable material. In some embodiments, the material used to form the base portion and the reinforcement portion are arranged such that grains, flutes, or other physical properties of the material are oriented at an angle to one another. For example, in one embodiment, the base portion is formed of a corrugated paperboard having flutes aligned to extend from panel 722 toward panel 724, and the reinforcement portion is formed of a corrugated paperboard having flutes aligned to extend from panel 732 toward panel 734 such that the flutes in panels 726, 736 are perpendicular to one another when product tray 710 is erected. The base portion and the reinforcement portion combine to form product tray 710 having multi-ply walls 713, 717, 719 and floor 711 that are stronger and more resistant to sagging than a tray having single-ply walls and floor.

In illustrative embodiments, a shelf-ready corrugated box display tray is provided. An oversized display window is formed along a length side of the tray. The tray resists sagging even without the use of a support divider. The tray is arranged to maximize strength and minimize material. The tray minimizes crush from side grab machinery in handling during unloading. The tray has stacking features to display product.

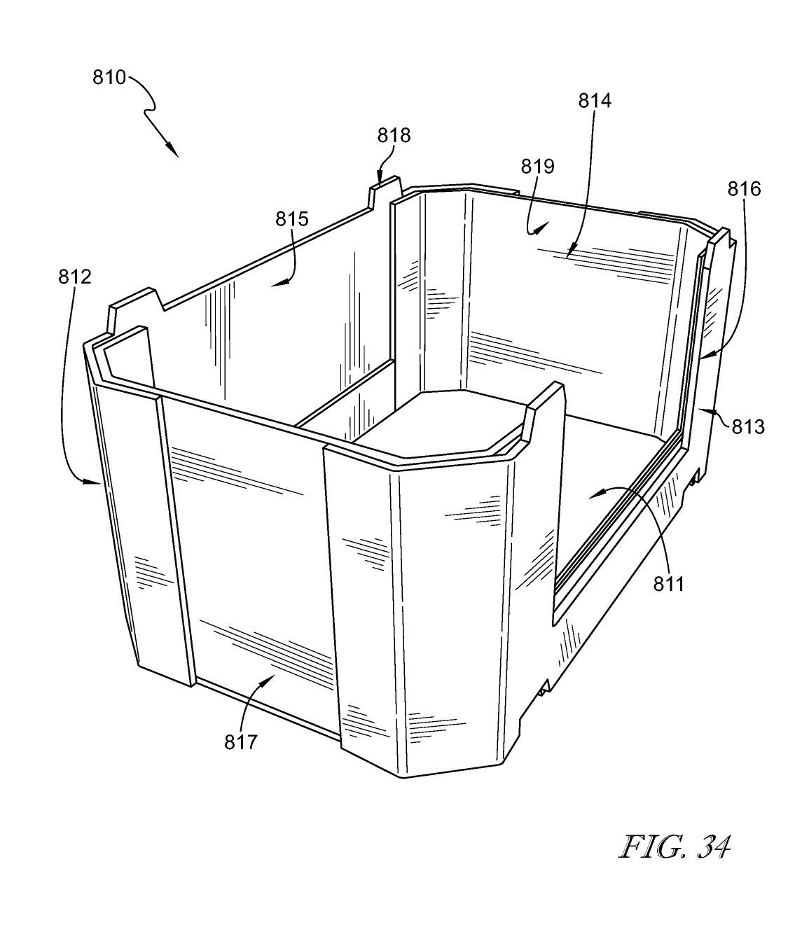

Another embodiment of a product tray 810 in accordance with the present disclosure is shown in FIG. 34. Product tray 810 includes body 812 defining a product-storage space 814 and a product-view window 816 extending through body 812 into product-storage space 814. Product-storage space 814 is configured to receive and hold product for transportation to and display in a retail location. Product-view window 816 allows a consumer at the retail location to view the product stored in product tray 810.

Body 812 of product tray 810 includes a front wall 813, a back wall 815 spaced apart from front wall 813, a pair of side walls 817, 819 extending from front wall 813 to the back wall 815, and a floor 811 as shown in FIG. 34. Front wall 813 is formed to include product-view window 816. Upper corners of product tray 810 form a platform for receiving another product tray 810 thereon and define alignment tabs 818 to aid in stacking of product trays 810.

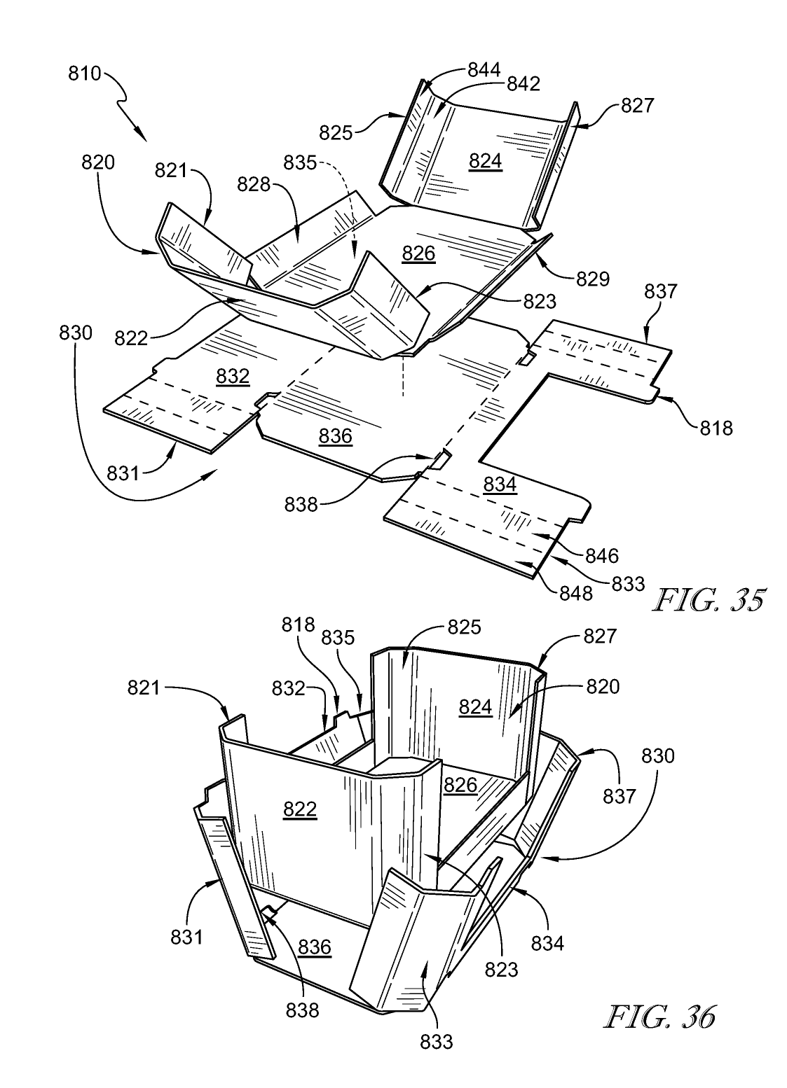

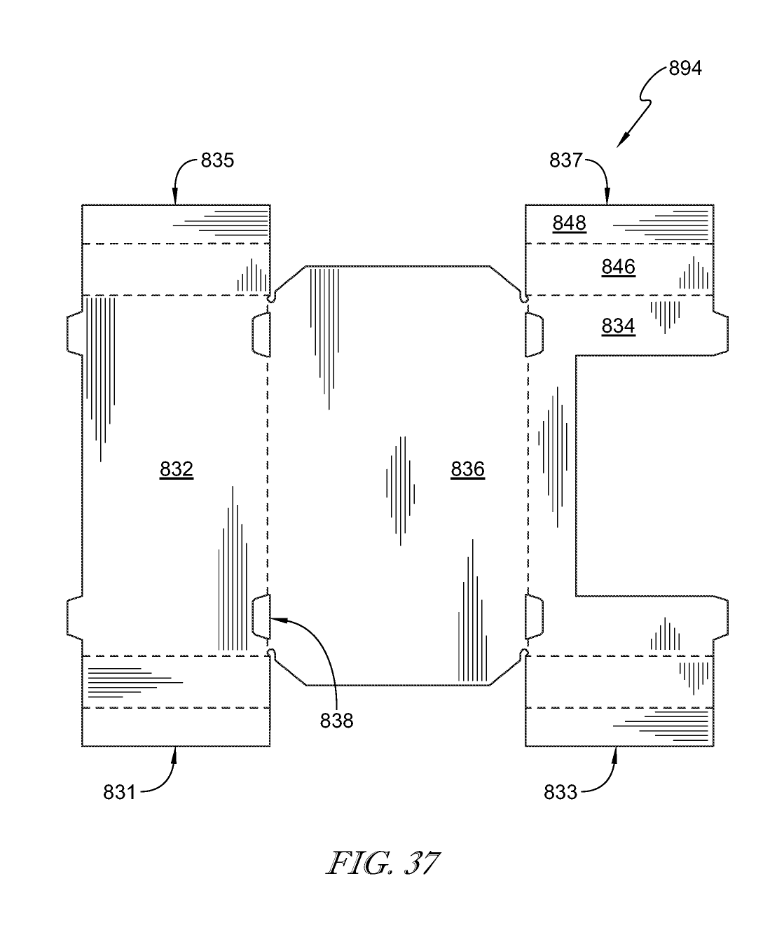

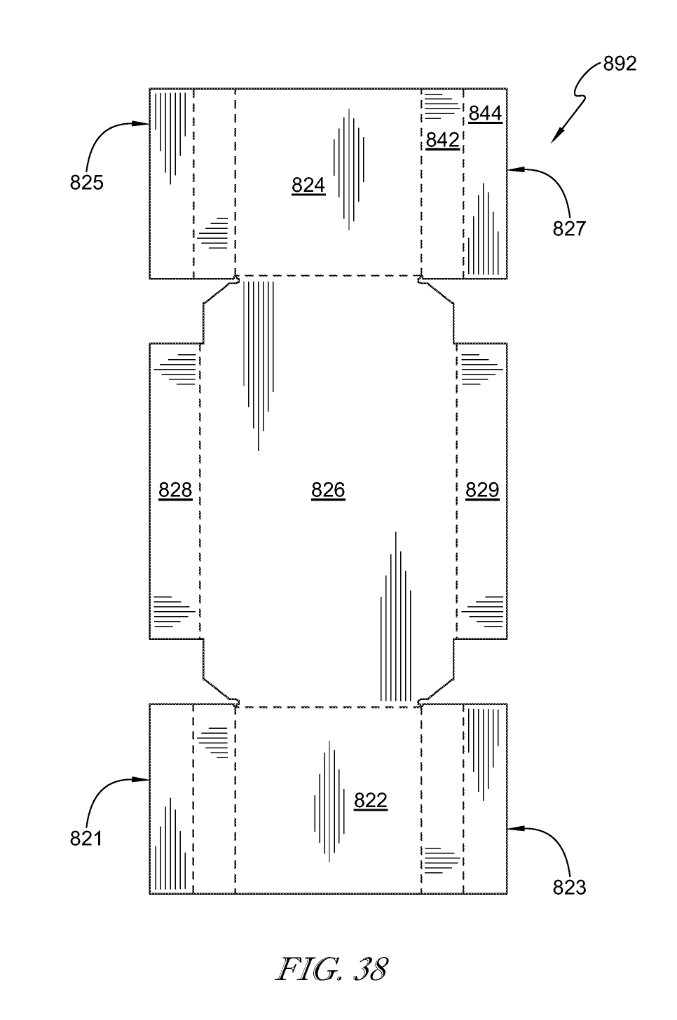

Product tray 810 is formed from a base portion 820 and a reinforcement portion 830 that attaches to base portion 820 as suggested in FIGS. 35 and 36. Base portion 820 is formed from a base blank 892 shown in FIG. 38 and reinforcement portion 830 is formed from a reinforcement blank 894 shown in FIG. 37. Base blank 892 and reinforcement blank 894 each includes a plurality of panels that fold relative to one another to erect base portion 820 and reinforcement portion 830.

Base portion 820 includes base panels 822, 824, 826 as shown in FIGS. 35 and 36. Base flaps 821, 823, 825, 827, 828, 829 are coupled to and extend from panels 822, 824, 826. Each of flaps 821, 823, 825, 827 includes a connector strip 842 extending from one of panels 822, 824 and an end strip 844 extending from connector strip 842. Connector strips 842 form beveled corner edges of base portion 820 when erected as suggested in FIGS. 34-36.

Reinforcement portion 830 includes reinforcement panels 832, 834, 836 as shown in FIGS. 35 and 36. Reinforcement flaps 831, 833, 835, 837 are coupled to and extend from panels 832, 834. Each of flaps 831, 833, 835, 837 includes a connector strip 846 extending from one of panels 832, 834 and an end strip 848 extending from connector strip 846. Connector strips 846 form beveled corner edges of reinforcement portion 830 when erected as suggested in FIGS. 34-36. Panels 832, 834 are formed to define alignment tabs 818. Slots 838 of reinforcement portion 830 (shown in FIG. 35) are configured to receive alignment tabs 818 of a lower product tray 810 to aid in alignment of product trays 810 during stacking.

In one illustrative embodiment for erecting product tray 810, panels 822, 824, 826 and flaps 821, 823, 825, 827, 828, 829 of base portion 820 are folded relative to one another to form base portion 820 as suggested in FIGS. 35 and 36. Panel 836 of reinforcement portion 830 engages with panel 826 of base portion 820 to define floor 811. Panel 834 of reinforcement portion 830 is folded relative to panel 836 to engage with flaps 823, 827, 829 of base portion 820 to form front wall 813. Panel 832 of reinforcement portion 830 is folded relative to panel 836 to engage with flaps 821, 825, 828 of base portion 820 to form back wall 815. Flaps 831, 833 of reinforcement portion 830 are folded relative to panels 832, 234, respectively, to engage with panel 822 of base portion 820 to form side wall 817. Flaps 835, 837 of reinforcement portion 830 are folded relative to panels 832, 834, respectively, to engage with panel 824 of base portion 820 to form side wall 819. Connector strips 842, 846 extend from panels 832, 834 to panels 822, 824 when product tray 810 is erected.

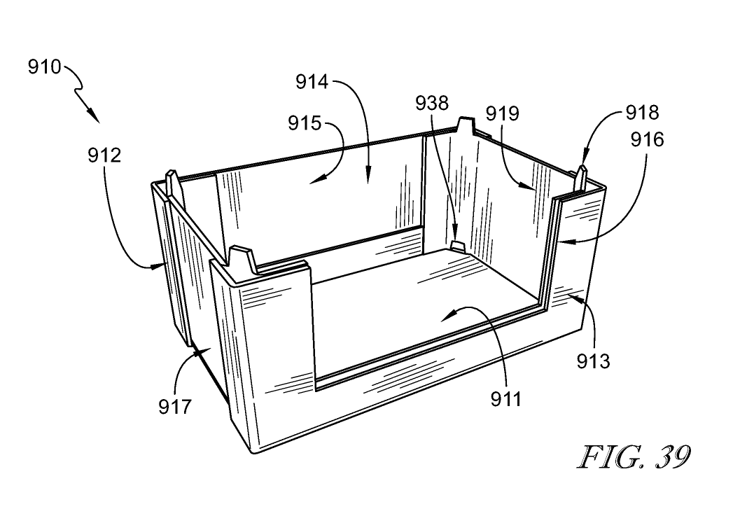

Another embodiment of a product tray 910 in accordance with the present disclosure is shown in FIG. 39. Product tray 910 includes body 912 defining a product-storage space 914 and a product-view window 916 extending through body 912 into product-storage space 914. Product-storage space 914 is configured to receive and hold product for transportation to and display in a retail location. Product-view window 916 allows a consumer at the retail location to view the product stored in product tray 910.

Body 912 of product tray 910 includes a front wall 913, a back wall 915 spaced apart from front wall 913, a pair of side walls 917, 919 extending from front wall 913 to the back wall 915, and a floor 911 as shown in FIG. 39. Front wall 913 is formed to include product-view window 916. Upper corners of product tray 910 form a platform for receiving another product tray 910 thereon and define alignment tabs 918 to aid in stacking of product trays 910.

Product tray 910 is similar to product tray 210 shown in FIGS. 11 and 12, with one difference being that product tray 910 does not include lock tabs 239. Notches 938 are formed into lower corners of product tray 910 and configured to receive alignment tabs 918 of a lower product tray 910 to aid in alignment of product trays 910 during stacking.

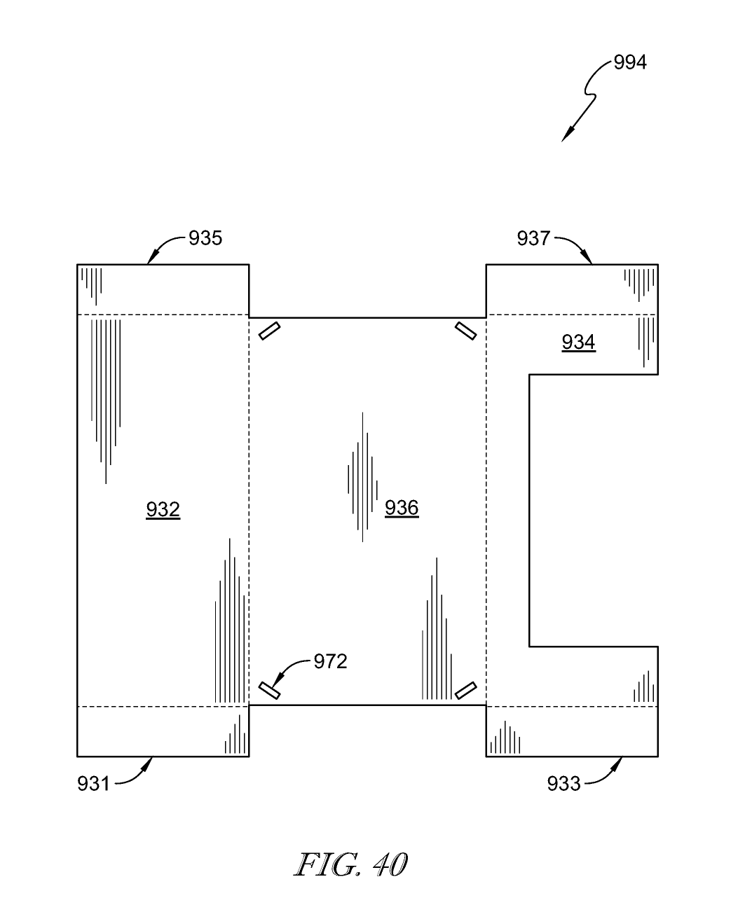

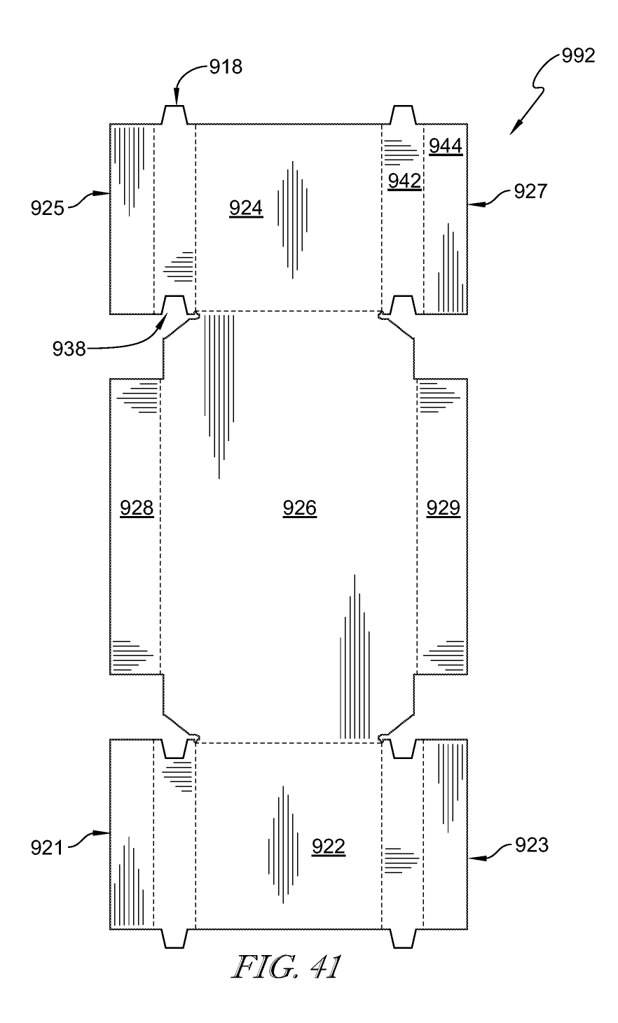

Product tray 910 is formed from a base portion and a reinforcement portion that attaches to the base portion as suggested in FIG. 39. The base portion is formed from a base blank 992 shown in FIG. 41 and the reinforcement portion is formed from a reinforcement blank 994 shown in FIG. 40. Base blank 992 and reinforcement blank 994 each includes a plurality of panels that fold relative to one another to erect the base portion and the reinforcement portion.

Base blank 992 includes base panels 922, 924, 926 as shown in FIG. 41. Base flaps 921, 923, 925, 927, 928, 929 are coupled to and extend from panels 922, 924, 926. Each of flaps 921, 923, 925, 927 includes a connector strip 942 extending from one of panels 922, 924 and an end strip 944 extending from connector strip 942. Connector strips 942 are formed to define notches 938 and alignment tabs 918 and arranged to form beveled corner edges of the base portion when erected as suggested in FIG. 39.

Reinforcement blank 994 includes reinforcement panels 932, 934, 936 as shown in FIG. 40. Reinforcement flaps 931, 933, 935, 937 are coupled to and extend from panels 932, 934. Slots 972 are formed through panel 936 and arranged to allow alignment tabs 918 of a lower product tray 910 to pass through the reinforcement portion and into notched 938 of the upper product tray 910 to aid in alignment of product trays 910 during stacking.

In one illustrative embodiment for erecting product tray 910, panels 922, 924, 926 and flaps 921, 923, 925, 927, 928, 929 of base blank 992 are folded relative to one another to form the base portion. Panel 936 of the reinforcement blank 994 engages with panel 926 of the base portion to define floor 911. Panel 934 of reinforcement blank 994 is folded relative to panel 936 to engage with flaps 923, 927, 929 of the base portion to form front wall 913. Panel 932 of reinforcement 994 is folded relative to panel 936 to engage with flaps 921, 925, 928 of the base portion to form back wall 915. Flaps 931, 933 of reinforcement blank 994 are folded relative to panels 932, 934, respectively, to engage with panel 922 of the base portion to form side wall 917. Flaps 935, 937 of reinforcement blank 994 are folded relative to panels 932, 934, respectively, to engage with panel 924 of the base portion to form side wall 919. Connector strips 942 extend from panels 932, 934 to flaps 931, 933, 935, 937 when product tray 910 is erected.

In the illustrative embodiment, the base portion and the reinforcement portion of product tray 910 are bonded to one another, such as with adhesive, tape, or mechanical fasteners for example. In some embodiments, only sections of the base portion and the reinforcement portion are bonded to one another, such as panels 926, 936 for example. It is within the scope of the present disclosure to make product trays 910 from a variety of materials including corrugated paperboard, folding carton, solid fiber, plastic sheeting, plastic corrugated, combinations thereof, or any other suitable material. In some embodiments, the material used to form the base portion and the reinforcement portion are arranged such that grains, flutes, or other physical properties of the material are oriented at an angle to one another. For example, in one embodiment, the base portion is formed of a corrugated paperboard having flutes aligned to extend from panel 922 toward panel 924, and the reinforcement portion is formed of a corrugated paperboard having flutes aligned to extend from panel 932 toward panel 934 such that the flutes in panels 926, 936 are perpendicular to one another when product tray 910 is erected. The base portion and the reinforcement portion combine to form product tray 910 having multi-ply walls 913, 915, 917, 919 and floor 911 that are stronger and more resistant to sagging than a tray having single-ply walls and floor.

In illustrative embodiments, a box former erects the shelf-ready display tray from two separate corrugated parts that cross in a bottom area (or floor). In one example, the two parts are glued along the bottom and then at four glue tabs to form vertical sides of the tray. The bottom edge of display window can have a waved edge or a roll over edge. A printed support hand can fold from the center of the floor.

In illustrative embodiments, the display tray uses material efficiently, minimizes bottom sag (that can cause tray failure), allows for oversize display windows (length facing side) with heavier products, and allows displaying various products in a shelf ready display.

In illustrative embodiments, the corrugated display tray maximizes structural compressive strength, and resistance to bottom sag forces and structural window break down, while maximizing efficiency of material usage. The tray is formed from two components: a full flanged U-sheet with its corrugations oriented in the length direction and a partial flanged U-sheet with corrugations oriented across the width direction. They tray provides eight vertical stacking corners, due to the lamination of two components together, for enhanced stacking strength. The tray also provides a horizontal, formed 90 degree corner along the base (or floor) to maximize resistance to bottom sagging and to reinforce the display window against breakdown. This greatly strengthens the resistance to breakdown, particularly in the center of the display window where structural breakdown is often seen, especially in the center of the window area. The tray enhances stacking support and can achieve higher performance levels with less fiber usage. The components can be formed from the same or different materials. For example, one of the components can be reduced to lighter weight materials and even use differing flutes for the two components.

In illustrative embodiments, either of the two components could be on the inside or outside of the tray. Side walls of the tray can be inclined with captured stack tabs. The tray can include mitered corners on the inside component to resist nesting when lids or shoulders are not present. The tray can have stacking shoulders or recloseable lid features. Stacking tabs can be incorporated on one or both components. The tray can include corner L-stacking tabs for four-side alignment.

In illustrative embodiments, a base blank of sheet material includes a plurality of base panels, a first plurality of base flaps coupled along a first side of the plurality of base panels and a second plurality of base flaps coupled along an opposing second side of the plurality of base panels. The plurality of base panels includes a base-mid panel and a pair of base-end panels coupled to opposing ends of the base-mid panel. The base panels and base flaps of the base blank are foldable relative to one another to form a base portion.

In illustrative embodiments, a reinforcement blank of sheet material includes a plurality of reinforcement panels, a first plurality of reinforcement flaps coupled along a first side of the plurality of reinforcement panels and a second plurality of reinforcement flaps coupled along an opposing second side of the plurality of reinforcement panels. The plurality of reinforcement panels includes a reinforcement-mid panel and a pair of reinforcement-end panels coupled to opposing ends of the reinforcement-mid panel. The reinforcement panels and reinforcement flaps of the reinforcement blank are foldable relative to one another to form a reinforcement portion.

In illustrative embodiments, the base-mid panel overlaps with the reinforcement-mid panel when the base portion is bonded to the reinforcement portion. One of the base-end panels overlaps with the first plurality of reinforcement flaps and the other base-end panel overlaps with the second plurality of reinforcement flaps when the base portion is bonded to the reinforcement portion. One of the reinforcement-end panels overlaps with the first plurality of base flaps and the other reinforcement-end panel overlaps with the second plurality of base flaps when the base portion is bonded to the reinforcement portion.

1. A product tray comprising
a body having a front wall, a back wall spaced apart from the front wall, a pair of spaced apart side walls extending from the front wall to the back wall, and a floor extending between lower ends of the front wall and the back wall and between lower ends of the side walls, the body defining a product-storage space adapted to receive and hold product for transportation to and display in a retail location, and
a product-view window extending through at least one of the walls of the body into the product-storage space, the product-view window arranged to allow a consumer at the retail location to view the product stored in the product product-storage space,
wherein the body is formed of a sheet material, and the floor and the side walls are each formed to include two or more layers of the sheet material in thickness.

2. The product tray of claim 1, wherein the front wall and the back wall are each formed to include two or more layers of the corrugated board material in thickness.

3. The product tray of claim 1, wherein the product-view window extends through the front wall of the body.

4. The product tray of claim 1, wherein upper corners of the body are formed to define platforms configured to provide a supporting surface configured to receive an additional product tray thereon to form a stack of product trays.

5. The product tray of claim 4, further comprising one or more alignment tabs extending upwardly from the body and configured to engage with one or more slots formed in a lower portion of the additional product tray to align the product tray with the additional product tray in the stack of product trays.

6. A product tray comprising
a base portion formed from a base blank of sheet material having a plurality of panels foldable relative to one another, and
a reinforcement portion formed from a reinforcement blank of sheet material having a plurality of panels foldable relative to one another,
wherein the base portion and reinforcement portion are bonded to one another to define a front wall, a back wall spaced apart from the front wall, a pair of spaced apart side walls extending from the front wall to the back wall, and a floor extending between lower ends of the front wall and the back wall and between lower ends of the side walls, the front, back, and side walls and the floor together define a product-storage space adapted to receive and hold product for transportation to and display in a retail location, a product-view window extends through at least one of the walls into the product-storage space, the product-view window is arranged to allow a consumer at the retail location to view the product stored in the product product-storage space, and the floor and the side walls are each formed to include two or more layers of sheet material in thickness.

7. The product tray of claim 6, wherein the front wall and the back wall are each formed to include two or more layers of sheet material in thickness.

8. The product tray of claim 6, wherein the product-view window extends through the front wall.

9. The product tray of claim 6, further comprising platforms arranged at upper corners of the reinforcement portion and formed to provide a supporting surface configured to receive an additional product tray thereon to form a stack of product trays.

10. The product tray of claim 9, further comprising one or more alignment tabs extending upwardly from the reinforcement portion and configured to engage with one or more slots formed in a lower portion of the additional product tray to align the product tray with the additional product tray in the stack of product trays.

11. The product tray of claim 6, further comprising platforms arranged at upper corners of the base portion and formed to provide a supporting surface configured to receive an additional product tray thereon to form a stack of product trays.

12. The product tray of claim 11, further comprising one or more alignment tabs extending upwardly from the base portion and configured to engage with one or more slots formed in a lower portion of the additional product tray to align the product tray with the additional product tray in the stack of product trays.

13. The product tray of claim 6, wherein the sheet material of the base blank includes a plurality of flutes extending along the sheet material in a first direction, wherein the sheet material of the reinforcement blank includes a plurality of flutes extending along the sheet material in a second direction, and wherein the base portion and reinforcement portion are bonded together such that the first direction and the second direction are perpendicular to one another.

14. The product tray of claim 6, wherein sections of the base portion overlap with sections of the reinforcement portion to provide the two or more layers of sheet material.

15. The product tray of claim 6, wherein the base portion is formed to define a product divider having a divider panel, a support panel, and a lock tab, wherein the divider panel is foldably coupled to the support panel, wherein the support panel is foldably coupled to a section of the base portion, and wherein the lock tab is foldably coupled to the support panel to engage with the divider panel and hold the product divider in an erected position.

16. A product tray comprising
a base blank of sheet material having a plurality of base panels, a first plurality of base flaps coupled along a first side of the plurality of base panels and a second plurality of base flaps coupled along an opposing second side of the plurality of base panels, the plurality of base panels including a base-mid panel and a pair of base-end panels coupled to opposing ends of the base-mid panel, the base panels and base flaps of the base blank foldable relative to one another to form a base portion, and
a reinforcement blank of sheet material having a plurality of reinforcement panels, a first plurality of reinforcement flaps coupled along a first side of the plurality of reinforcement panels and a second plurality of reinforcement flaps coupled along an opposing second side of the plurality of reinforcement panels, the plurality of reinforcement panels including a reinforcement-mid panel and a pair of reinforcement-end panels coupled to opposing ends of the reinforcement-mid panel, the reinforcement panels and reinforcement flaps of the reinforcement blank foldable relative to one another to form a reinforcement portion,
wherein the base portion and reinforcement portion are bonded to one another to define a front wall, a back wall spaced apart from the front wall, a pair of spaced apart side walls extending from the front wall to the back wall, and a floor extending between lower ends of the front wall and the back wall and between lower ends of the side walls, the front, back, and side walls and the floor together define a product-storage space adapted to receive and hold product for transportation to and display in a retail location, a product-view window extends through at least one of the walls into the product-storage space, the product-view window is arranged to allow a consumer at the retail location to view the product stored in the product product-storage space, and the front, back, and side walls and the floor are each formed to include two or more layers of sheet material in thickness.

17. The product tray of claim 16, wherein the base-mid panel overlaps with the reinforcement-mid panel when the base portion is bonded to the reinforcement portion, wherein one of the base-end panels overlaps with the first plurality of reinforcement flaps and the other base-end panel overlaps with the second plurality of reinforcement flaps when the base portion is bonded to the reinforcement portion, and wherein one of the reinforcement-end panels overlaps with the first plurality of base flaps and the other reinforcement-end panel overlaps with the second plurality of base flaps when the base portion is bonded to the reinforcement portion.

18. The product tray of claim 16, further comprising platforms arranged at upper corners of the reinforcement portion and formed to provide a supporting surface configured to receive an additional product tray thereon to form a stack of product trays, and further comprising one or more alignment tabs extending upwardly from the reinforcement portion and configured to engage with one or more slots formed in a lower portion of the additional product tray to align the product tray with the additional product tray in the stack of product trays.

19. The product tray of claim 16, further comprising platforms arranged at upper corners of the base portion and formed to provide a supporting surface configured to receive an additional product tray thereon to form a stack of product trays, and further comprising one or more alignment tabs extending upwardly from the base portion and configured to engage with one or more slots formed in a lower portion of the additional product tray to align the product tray with the additional product tray in the stack of product trays.

20. The product tray of claim 16, wherein the sheet material of the base blank includes a plurality of flutes extending along the sheet material in a first direction, wherein the sheet material of the reinforcement blank includes a plurality of flutes extending along the sheet material in a second direction, and wherein the base portion and reinforcement portion are bonded together such that the first direction and the second direction are perpendicular to one another.
